(19) United States
(12) Patent Application Publication
(10) Pub. No.: US 2026/0368357 A1
(43) Pub. Date: Nov. 19, 2026

(54) Privacy-preserving travel location coding using and on-device spatial index

(71) Applicant: Benjamin Guild, Covina, CA (US)

(72) Inventor: Benjamin Guild, Covina, CA (US)

(21) Appl. No.: 19/676,231

(22) Filed: May 13, 2026

Related U.S. Application Data
(60) Provisional application No. 63/804,824, filed on May 13, 2025.
(60) Provisional application No. 63/888,314, filed on Sep. 26, 2025.

(51) Int. Cl. G06F 21/62

(52) U.S. Cl. CPC G06F 21/6245

(57) ABSTRACT

Techniques are described for privacy-preserving location coding using a spatial index. A mobile device stores or accesses a spatial index that maps spatial subdivisions to coarse location identifiers. The mobile device obtains a location signal associated with a user, such as a device-derived location, calendar-derived location, user-entered location, travel record, scanned credential, peer-shared location object, or motion-derived travel signal. The mobile device resolves the location signal using the spatial index to generate a hierarchical location coding corresponding to a general location, destination, travel area, event area, or other geographic area. A privacy-preserving location object may be generated based on the hierarchical location coding while omitting raw geographic coordinates. The location object may be displayed, encrypted, shared, used to generate a ticket-like interface, used to compose an itinerary segment, or used to initiate a controlled interaction.

### RELATED APPLICATIONS

This application claims priority to U.S. Provisional Patent Appl Ser. Nos. 63/804,824, filed on May 13, 2025, and 63/888,314, filed on Sep. 26, 2025, both entitled “TRAVEL ITINERARY COORDINATION USING CALENDAR INTEGRATION AND SOCIAL GRAPH ONBOARDING” by Benjamin Guild, the contents of each of which are incorporated by reference herein.

### TECHNICAL FIELD

This disclosure relates generally to mobile computing, location processing, spatial indexing, and privacy-preserving communication of location information. More particularly, this disclosure relates to techniques for resolving travel-relevant location information on a mobile device using a reduced on-device spatial index and generating coarse, human-recognizable location codings that may be used for privacy-preserving location updates, shareable ticket-like interfaces, calendar-based itinerary composition, and social coordination.

### BACKGROUND

Mobile devices are increasingly used to support location-based services, travel planning, calendar management, social coordination, and communication of user availability or presence. Many mobile applications can obtain, process, display, or share location-related information in connection with navigation, mapping, travel, messaging, social networking, event planning, and other user-facing services. In many contexts, however, users may wish to preserve flexibility and control over who receives location-related information and what level of detail is disclosed. The manner in which location-related information is obtained, resolved, stored, labeled, transmitted, and displayed can also affect latency, network usage, battery consumption, storage requirements, user experience, and privacy.

Calendar, itinerary, mapping, social networking, and messaging applications may interact with location-related information in different ways. Some systems emphasize precise navigation or real-time tracking. Other systems emphasize scheduled events, travel reservations, social posts, group coordination, or user-controlled sharing. These different approaches may involve tradeoffs among precision, convenience, privacy, storage size, connectivity, computational load, and the degree to which location information is human-readable, machine-readable, shareable, or reusable across different application contexts.

### SUMMARY

The techniques herein are directed generally to privacy-preserving location coding and sharing using mobile devices. In particular, according to one or more embodiments described herein, a mobile device may store or access a reduced-scope spatial index configured to support resolution of location-related information into coarse, human-recognizable location codings. The spatial index may map spatial subdivisions, polygons, cells, hierarchical spatial identifiers, or other geographic regions to one or more location identifiers, such as continent identifiers, country identifiers, regional identifiers, local identifiers, transportation hub identifiers, time zone identifiers, branch identifiers, event identifiers, body-of-water identifiers, or other location-related codes.

In one or more embodiments, a mobile device may obtain a location signal associated with a user, such as a device-derived location, a calendar-derived location, a user-entered location, a travel-related record, a scanned credential, a peer-shared location object, or a motion-derived travel signal. The mobile device may resolve the location signal using the spatial index to generate a hierarchical location coding corresponding to a general location, destination, travel area, event area, or other geographic area. In certain embodiments, this resolution may be performed locally on the mobile device without requiring transmission of raw geographic coordinates to a remote geocoding service. The resulting location coding may represent location-related information at a level of detail selected or controlled by the user, such as a city-level, region-level, country-level, travel-hub-level, branch-level, or optional precision-enhanced level.

The mobile device may generate a communicable location data structure, referred to herein in some embodiments as a “location object,” “coded location object,” or “privacy-preserving location object,” based on the hierarchical location coding. The location object may function as a container or payload for communicating, storing, displaying, synchronizing, or otherwise processing a location-related state or update. The location object may omit raw geographic coordinates and may instead include one or more coded location identifiers, temporal information (e.g., time, date, etc.), visibility settings, precision settings, user-selected descriptors, expiration information, cryptographic information, sharing permissions, or other metadata. The location object may be stored locally, synchronized, encrypted, transmitted to selected recipients, displayed within an application interface, be used to update a user profile or presence indication, or be used as an input to one or more downstream location-based workflows.

In one or more embodiments, the coded location object may be used to generate a ticket-like interface that visually represents a current location, future destination, travel plan, itinerary segment, group plan, event presence, or other location-related update. The ticket-like interface may display a short-form location identifier or other human-recognizable code and may include a machine-readable element, such as a barcode, QR code, visual pattern, watermark, encoded text strip, or other scannable or importable element. The machine-readable element may encode or reference a ticket payload, credential, invitation, signature, nonce, expiration value, revocation status, permission scope, or access-control policy.

In further embodiments, a ticket-like object may be shared within an application, exported as an image, posted to another platform, sent through a messaging application, scanned by a camera, imported from a file or photo library, or otherwise communicated to another device. A recipient device may process the ticket-like object to validate a credential, request a connection, follow a public or semi-public profile, access shared location information, clone or join a plan, or initiate another controlled interaction. In this manner, a location coding generated from a spatial index may be used not only for display of location-related information, but also as part of a controlled sharing and onboarding mechanism.

In one or more embodiments, calendar entries, travel records, detected movement, peer updates, user-entered destinations, scanned passes, or other signals may be used to compose destination blocks or itinerary segments. Such destination blocks or itinerary segments may be resolved to coded location objects and organized according to time, location, sharing status, user identity, group membership, or other contextual information. The system may present draft, tentative, confirmed, shared, private, public, or group-based location updates, and may prompt a user to confirm, edit, share, suppress, or remove one or more updates based on changes in location coding, calendar information, motion information, or user-selected visibility settings.

While various embodiments have been discussed in the summary above, it should be appreciated that not necessarily all embodiments include the same features and some of the features described above are not necessary for all embodiments. Numerous additional features, embodiments, and benefits of various embodiments are discussed in the detailed description which follows.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example simplified computer network;

FIG. 2 illustrates an example computing device configured to support privacy-preserving location coding using an on-device spatial index;

FIG. 3A illustrates an example spatial index data structure for resolving location-related information into hierarchical location codings;

FIG. 3B illustrates an example multi-scale spatial subdivision hierarchy for generating location codings using spatial subdivisions having different relative scales, resolutions, or boundary geometries;

FIG. 4 illustrates an example procedure for generating a privacy-preserving location object using a spatial index;

FIG. 5 illustrates an example procedure for generating, sharing, importing, and validating a ticket-like object based on a coded location object;

FIG. 6 illustrates an example ticket-like interface for displaying and sharing location-related information;

FIG. 7 illustrates an example calendar-augmented itinerary interface in which destination blocks or itinerary segments may be generated using coded location objects;

FIGS. 8A-8B illustrate example procedures for calendar-derived itinerary composition and motion-derived location update prompts;

FIG. 9 illustrates an example group, public profile, or social coordination interface using ticket-like objects and coded location updates;

FIGS. 10A-10F illustrate example user interface screens that may be used in connection with one or more embodiments of the privacy-preserving location coding, ticket-like sharing, itinerary composition, and social coordination techniques described herein;

FIG. 11 illustrates an example procedure for on-device spatial index location coding according to one or more embodiments herein;

FIG. 12 illustrates an example procedure for providing a ticket-like interface/machine-readable credential according to one or more embodiments herein;

FIG. 13 illustrates an example procedure for calendar-derived itinerary composition according to one or more embodiments herein;

FIG. 14 illustrates an example procedure for motion-derived location update prompts according to one or more embodiments herein;

FIG. 15 illustrates an example procedure for branch identifiers/optional precision descriptors according to one or more embodiments herein; and

FIG. 16 illustrates an example procedure for group/public profile/social coordination according to one or more embodiments herein.

### DESCRIPTION OF EXAMPLE EMBODIMENTS

A computer network is a distributed collection of nodes interconnected by communication links and segments for transporting signals or data between the nodes, such as personal computers, workstations, mobile devices, servers, routers, databases, or other devices. Many types of computer networks are available, including, but not limited to, local area networks (LANs), wide area networks (WANs), cellular networks, broadband networks, infrastructure or backhaul networks, public switched telephone networks (PSTNs), satellite networks, short-range wireless networks, and other wired or wireless networks.

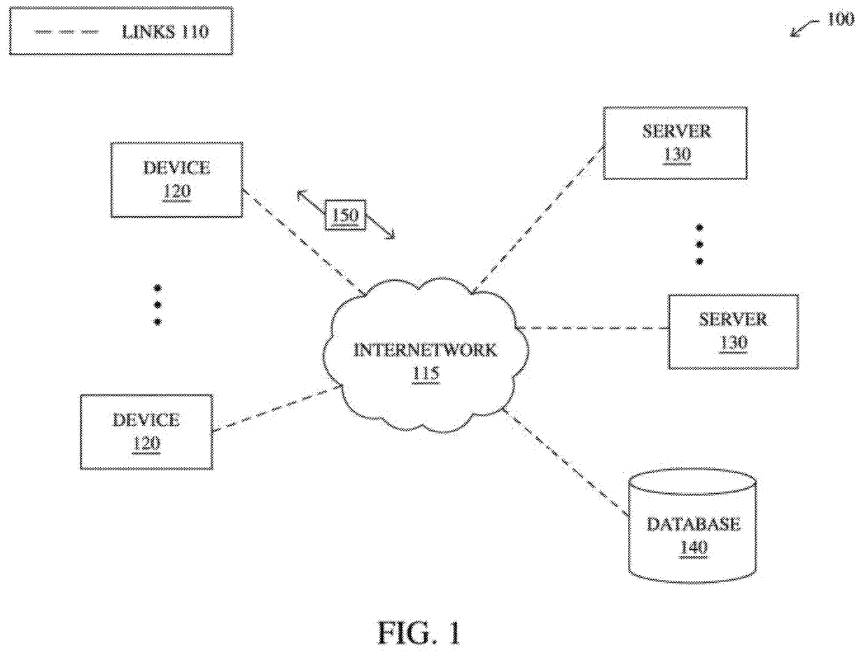

FIG. 1 illustrates an example simplified computer network 100. As shown, computer network 100 may include various devices communicating over links 110 and an internetwork 115, such as end devices 120, servers 130, databases 140, and other devices as will be appreciated by those skilled in the art. Data transmissions 150, such as packets, frames, messages, transmission signals, application data, encrypted payloads, synchronization data, spatial index updates, coded location objects, ticket payloads, or other data, may be exchanged among the nodes/devices of the computer network 100 using predefined communication protocols where appropriate over links 110.

End devices 120 may comprise different types of devices, such as personal computers, desktop computers, laptop computers, mobile devices, tablets, smartphones, wearable electronic devices, smart watches, smart vehicles, terminals, kiosks, augmented-reality devices, virtual-reality devices, or other computing devices. In many embodiments described herein, an end device 120 may comprise a mobile device operated by a user and configured to obtain, process, resolve, display, store, encrypt, transmit, or otherwise use location-related information.

Servers 130 and/or databases 140 may comprise singular servers and/or databases, server farms, database farms, cloud-based services, distributed storage services, synchronization services, account services, relay services, key-management services, spatial-index distribution services, ticket-validation services, revocation services, social graph services, or other computing resources. In certain embodiments, servers 130 and/or databases 140 may assist with account management, encrypted message relay, backup, synchronization, distribution of spatial index updates, verification of ticket credentials, or delivery of optional metadata. However, in some embodiments, one or more operations described herein may be performed locally on an end device 120 without requiring a server 130 to access raw geographic coordinates, precise user location information, or unencrypted location content.

The computer network 100 shown in FIG. 1 is merely one example. Other arrangements may be used, including centralized, distributed, decentralized, peer-to-peer, federated, mesh, hub-and-spoke, or hybrid arrangements. For example, one or more servers 130 may relay encrypted data between end devices 120 while being unable to read the contents of the encrypted data. In other embodiments, end devices 120 may directly exchange one or more coded location objects, ticket-like objects, invitations, keys, or other payloads. Thus, the network architecture may vary depending on implementation, security requirements, privacy settings, application design, or available communication infrastructure.

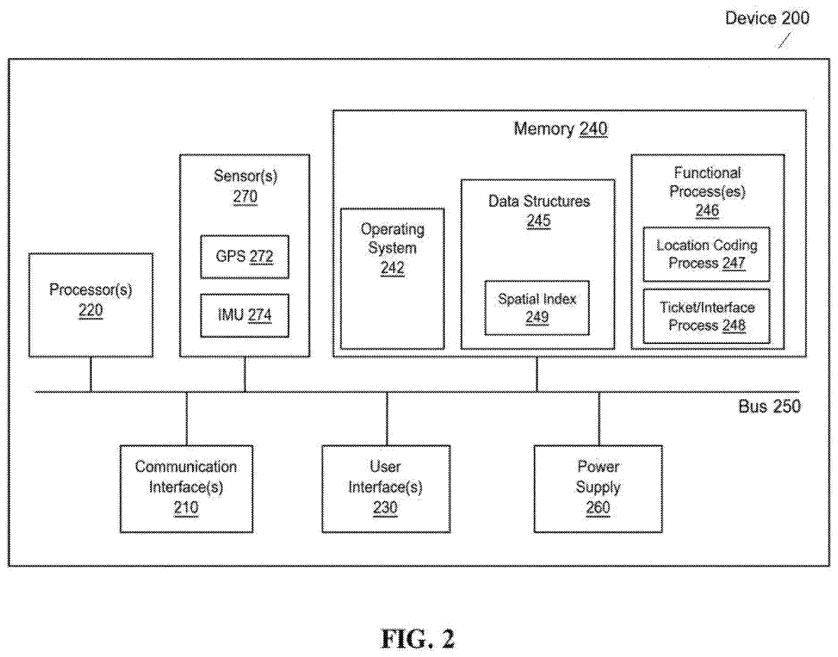

FIG. 2 is a simplified schematic block diagram of an example computing device (device 200) that may be used with one or more embodiments described herein, such as an end device 120, server 130, database 140, mobile device, wearable device, or other computing device. Illustratively, device 200 may include one or more communication interfaces 210, one or more processors 220, one or more user interfaces 230, a memory 240, and a power supply system 260 interconnected by a system bus 250 or other dedicated circuitry.

Communication interfaces 210 may include mechanical, electrical, radio-frequency, optical, or signaling circuitry for communicating data over wired and/or wireless links. For example, communication interfaces 210 may support cellular communication, Wi-Fi communication, Bluetooth communication, near-field communication (NFC), ultra-wideband communication, satellite communication, wired network communication, or other suitable communication techniques. In some embodiments, communication interfaces 210 may be used to receive spatial index updates, synchronize coded location objects, exchange encrypted ticket payloads, relay connection requests, retrieve optional metadata, or otherwise communicate information in connection with the techniques herein.

User interfaces 230 may include displays, touchscreens, keyboards, microphones, speakers, cameras, biometric sensors, haptic components, buttons, gesture sensors, or other input/output components. User interfaces 230 may be used to receive user selections, location-sharing preferences, visibility settings, precision settings, calendar permissions, ticket customization selections, confirmation inputs, scan inputs, or other inputs. User interfaces 230 may also be used to display location codings, ticket-like interfaces, calendar-derived itinerary segments, prompts, notifications, maps, user profiles, group interfaces, or other information.

Memory 240 may include a plurality of storage locations addressable by processor(s) 220 for storing software programs, instructions, modules, processes, data structures, and other information associated with the embodiments described herein. Processor(s) 220 may include hardware elements, processing circuitry, logic, or other components adapted to execute instructions and manipulate data structures. An operating system 242, portions of which may be resident in memory 240 and executed by processor(s) 220, may functionally organize the device by invoking operations in support of software processes, services, applications, and modules executing on the device.

Illustratively, memory 240 may store data structures 245 and one or more functional processes 246. In one or more embodiments, functional processes 246 may include a location coding process 247 and a ticket/interface process 248. Location coding process 247 may be configured to resolve location-related information into one or more hierarchical location codings using a spatial index, as described herein. Ticket/interface process 248 may be configured to generate, render, share, import, validate, or otherwise process ticket-like objects, itinerary interfaces, location updates, prompts, or related application interfaces. In other embodiments, location coding process 247 and ticket/interface process 248 may be combined, subdivided, distributed among multiple devices, implemented as part of one or more applications, or implemented as one or more services, libraries, operating-system extensions, or other software components.

In one or more embodiments, data structures 245 may include a spatial index 249. Spatial index 249 may comprise a locally stored, partially locally stored, cached, compressed, reduced-scope, hierarchical, or otherwise mobile-suitable data structure that maps spatial subdivisions to location identifiers. For example, spatial index 249 may map spatial cells, polygons, grid regions, tile identifiers, hierarchical spatial identifiers, geohash-like identifiers, H3-like identifiers, S2-like identifiers, administrative regions, transportation regions, event regions, bodies of water, or other geographic subdivisions to one or more location codings. Such location codings may include continent identifiers, country identifiers, regional identifiers, local identifiers, transportation hub identifiers, time zone identifiers, branch identifiers, event identifiers, ocean identifiers, sea identifiers, optional precision descriptors, or other human-readable or machine-readable location identifiers.

Device 200 may further include or access one or more sensors 270. Sensors 270 may include, for example, a satellite-based positioning receiver, such as a GPS receiver 272, an inertial measurement unit (IMU) 274, accelerometers, gyroscopes, magnetometers, barometers, altimeters, wireless signal sensors, proximity sensors, cameras, microphones, NFC readers, biometric sensors, or other sensors. In some embodiments, sensor data may be used as one possible source of location-related information or motion-related information. For example, device 200 may use sensor data to detect a travel event, infer a change in location context, scan a ticket-like object, capture a boarding pass, detect proximity to another device, or otherwise generate an input to location coding process 247.

It will be apparent to those skilled in the art that other processor and memory types, including various computer-readable media, may be used to store and execute program instructions pertaining to the techniques described herein. Further, while processes, modules, and data structures may be shown or described separately, those skilled in the art will appreciate that such processes, modules, and data structures may be combined, separated, distributed, replicated, virtualized, containerized, executed locally, executed remotely, or otherwise implemented in any suitable manner.

As noted above, mobile devices may process and communicate location-related information in many different contexts, including navigation, travel planning, calendar management, messaging, social coordination, event participation, and other user-facing services. Different application contexts may involve different levels of location detail, ranging from precise coordinates, addresses, or venues to more general geographic references. The manner in which location information is obtained, resolved, stored, labeled, transmitted, and displayed may also affect latency, network usage, battery consumption, storage requirements, user experience, and privacy. The following embodiments describe example techniques related to such location-related processing and communication.

### On-Device Spatial Index and Location Coding

In one or more embodiments, a mobile device may store, access, cache, or otherwise maintain a spatial index configured to support resolution of location-related information into one or more location codings. The spatial index may be stored locally on the mobile device, partially stored locally and partially accessed from one or more remote resources, or dynamically updated based on user activity, geographic area, travel plans, application usage, available storage, or other factors. In certain embodiments, the spatial index may be reduced in scope or level of detail relative to a full geographic, mapping, address, or point-of-interest database, such that the spatial index is suitable for storage, searching, and use on a mobile device.

The spatial index may include mappings between spatial subdivisions and location identifiers. Such spatial subdivisions may include cells, polygons, tiles, grid regions, geohashes, hierarchical spatial identifiers, H3-like cells, S2-like cells, administrative regions, transportation regions, natural regions, event regions, bodies of water, or any other suitable spatial representation. The location identifiers may include, for example, continent codes, country codes, regional codes, local codes, transportation hub codes, time zone identifiers, branch identifiers, event identifiers, ocean identifiers, sea identifiers, ephemeral-region identifiers, or other human-readable or machine-readable identifiers.

In some embodiments, the spatial index may be configured to resolve location-related information at a level of detail associated with travel, social coordination, itinerary composition, or user-controlled location sharing. For example, the spatial index may resolve a location to a country, region, city, airport area, travel hub, destination area, neighborhood, landmark area, park, island, event area, body of water, or other coarse geographic area. In certain embodiments, the spatial index may intentionally omit, compress, generalize, or separately store certain details, such as street-address data, parcel-level data, building-level data, fine-grained point-of-interest data, or other information not required for a particular implementation.

As used herein, a “coarse” location identifier or location coding does not necessarily imply reduced accuracy, erroneous resolution, or imprecise processing. Rather, the term “coarse” may refer to a location representation that intentionally corresponds to a generalized geographic area, hierarchical location level, travel-relevant region, or user-selected precision level, rather than to raw coordinates, a street address, or another fine-grained location representation. For example, a coarse location coding may accurately identify a city, region, transportation hub, destination area, event area, branch region, body of water, or other generalized location while omitting more specific location information to support privacy, reduced storage requirements, lower network usage, or user-controlled disclosure, as described in greater detail herein.

In one or more embodiments, the spatial index may be configured to support generation, selection, ranking, or display of compact human-recognizable location identifiers. For example, a location identifier may comprise a short-form alphabetic, numeric, alphanumeric, symbolic, or mixed-character code that can be recognized, remembered, typed, displayed, spoken, searched, or shared by a user more readily than raw coordinates, full addresses, or long place descriptions. In some embodiments, such compact identifiers may include two-character codes, three-character codes, airport-code-like identifiers, transportation-hub-like identifiers, country or region codes, platform-generated identifiers, or other short-form codes, although longer or shorter identifiers may be used where appropriate for disambiguation, geography, language, availability, or implementation. As an example, “JP” may mean “Japan”, while “NYC” may mean “New York City”, and so on.

In certain embodiments, the spatial index may select or organize such compact identifiers based on relative recognizability within a parent region or among sibling regions. For example, a highly recognizable metropolitan area, transportation hub, destination area, or other significant locality may be assigned or associated with a compact identifier that effectively represents a broader travel-relevant area in one context, while smaller neighboring cities, suburbs, districts, towns, or branch regions may be represented as inner, branch, or otherwise subordinate identifiers within or adjacent to that context. As a specific example, if the user is in “NYC” (coded region), an optional text tag may be added for a specific area (as an “inner branch”) within New York City, such as “Wall Street” or “SoHo”, etc. The correspondence between compact identifiers and geographic scale need not be uniform across countries, regions, or parent areas. Rather, the coding may be shaped according to relative scale, distance, population, transit patterns, market recognition, sibling-region distinction, user expectations, or other factors that support intuitive human-recognizable location sharing while preserving privacy. In some embodiments, a compact identifier may function as a top-level or prominent display code for a given coded location object, even though the underlying spatial index may maintain additional parent, sibling, branch, time-zone, water-region, or optional precision information.

A location coding generated using the spatial index may include one or more hierarchical location elements. For example, a location coding may include a continent identifier, a country identifier, a regional identifier, a local identifier, a time zone identifier, and, where applicable, a branch identifier or optional precision descriptor. In other examples, a location coding may include an ocean identifier, sea identifier, water-region identifier, route identifier, event identifier, or ephemeral-region identifier. The number and type of location elements included in a location coding may vary based on geography, user preference, application context, data availability, precision setting, privacy setting, or implementation.

In some embodiments, hierarchical location elements may include both higher-level context identifiers and relative within-region scale identifiers. Higher-level context identifiers may include, for example, continent identifiers, country identifiers, time-zone identifiers, ocean identifiers, sea identifiers, water-region identifiers, or other broad contextual identifiers. Separately, within a country, territory, land region, island region, or other comparable parent context, the location coding may include relative scale levels, such as those representing a relative outer level, central level, and inner level. These relative levels need not correspond to fixed governmental or administrative categories. For example, an outer level may correspond to a state, province, territory, district, island group, metropolitan region, travel region, or other broad area within or associated with a country or comparable parent context. A central level may correspond to a settlement, city, municipality, transportation hub, destination area, large event area, island, large park or natural feature, or other significant human-recognizable locality within or associated with the outer level. An inner level may correspond to a subregion, branch region, neighborhood, venue area, terminal area, attraction area, smaller settlement, or other more specific location within or associated with the central level. These relative levels may be used differently in different geographies. For example, a metropolitan area may operate as a central level in one context, while a district, island group, city-scale region, or destination corridor may serve a similar relative function in another geography. Thus, regional, local, outer, central, inner, branch, or other hierarchical identifiers need not correspond to the same administrative category across all countries or regions.

As used herein, a “regional identifier” may refer to an intermediate or broader location identifier relative to a local identifier, and a “local identifier” may refer to a more specific locality or travel-relevant area relative to a regional identifier. Either type of identifier may include, reference, or be associated with a name of a place, settlement, destination area, transportation hub, event area, park, island, region, or other human-recognizable geographic or travel-relevant area.

In one example, a location coding may include a country code, a region code, and a local code corresponding to a city, municipality, transportation hub, or recognized destination area. In another example, a location coding may omit one or more intermediate levels where such levels are unnecessary, unavailable, redundant, or not meaningful in a particular geographic context. For instance, a city-state, island region, remote landmark, body of water, national park, event area, or other region may be represented using a different hierarchy than a conventional country-region-city hierarchy. Thus, the location coding need not follow a single fixed administrative hierarchy and may instead be adapted to represent location information in a manner suitable for a particular geography or use case.

In certain embodiments, one or more location identifiers may be based on, derived from, adapted from, associated with, or mapped to existing code systems, such as airport codes, transportation codes, country codes, regional codes, time zone identifiers, or other standardized or commonly recognized identifiers. In other embodiments, one or more location identifiers may be generated by the system, assigned by an operator, derived from a spatial cell arrangement, associated with an event, sponsored region, organization, venue, landmark, or community, or otherwise defined for use within the application. The same spatial index may therefore support both standardized identifiers and platform-specific identifiers.

A location coding may be derived from any suitable location signal. For example, the location signal may include a device-derived coordinate, operating-system location output, wireless network context, user-entered location string, search query, calendar entry, travel reservation, scanned travel credential, ticket-like object, imported image, message content, peer-shared update, motion-derived travel signal, or other input. In some embodiments, the mobile device may use the spatial index to resolve the location signal locally, without transmitting raw geographic coordinates or precise location information to a remote geocoding service. In other embodiments, local resolution may be supplemented by remote services, cached metadata, user confirmation, or additional datasets.

In one or more embodiments, the spatial index may support generation of a location object. The location object may include the location coding and may omit raw geographic coordinates, precise addresses, or other fine-grained location information unless such information is expressly selected, appended, or authorized. The coded location object may further include temporal information, confidence information, source information, user-selected visibility settings, precision settings, expiration information, cryptographic information, sharing permissions, display attributes, or other metadata. The coded location object may be stored locally, encrypted, synchronized, displayed, shared with selected recipients, embedded in a ticket-like object, associated with a calendar-derived itinerary segment, or used to trigger, suppress, or modify one or more user prompts. (Notably, as used herein, temporal/time information/ranges may include time information, date information, date ranges, time ranges, start times, end times, arrival times, departure times, expiration times, recurrence information, durations, or other information indicating when a location-related state, update, itinerary segment, ticket-like object, or sharing permission is applicable.)

In some embodiments, the spatial index may be updated or distributed in packages. For example, a mobile device may receive a global coarse index, a regional index, a country-level package, a city-level package, an event-specific package, a body-of-water package, or a user-specific package. The mobile device may determine which packages to store or update based on current, past, or future location(s), anticipated travel, calendar events, user preferences, available storage, network state, subscription status, group membership, or other factors. In certain embodiments, a coarse spatial index may remain available for broad offline use, while more detailed optional precision information may be downloaded, cached, or activated only for selected areas or selected time periods.

The spatial index may also support search, matching, disambiguation, and ranking operations. For example, the mobile device may match user-entered text, calendar text or location metadata, ticket text, image-derived text, travel-record text, or other location-related data against aliases, codes, metadata, parent-child relationships, spatial containment relationships, time zone information, transportation relationships, event metadata, or other index information. Where multiple candidate location codings are identified, the mobile device may rank, filter, combine, or present candidates based on user context, calendar context, device context, travel history, peer activity, current or expected time, proximity, popularity, permissions, or other factors.

In one or more embodiments, one or more automated software agents, artificial-intelligence-assisted agents, large-language-model-based agents, machine-learning systems, rule-based software processes, data-validation processes, human-assisted review systems, or combinations thereof may be used to build, audit, validate, update, or maintain the spatial index or one or more packages thereof. For example, an agent may identify candidate spatial subdivisions, compare location records against external or internal data sources, detect inconsistent aliases or boundaries, propose updates to location coding records, identify duplicate or conflicting records, validate parent-child relationships, or flag changes for human review. In some embodiments, multiple agents or review processes may independently evaluate the same or related portions of the spatial index to reduce errors, identify stale records, or improve consistency across geographic regions. Updates to the spatial index may be tracked using version identifiers, audit logs, change records, ledger records or blockchains, database records, cryptographic hashes, signatures, timestamps, reviewer identifiers, agent identifiers, or other provenance information. A mobile device may receive spatial index updates as part of an application update, as an incremental package, as a region-specific package, as an event-specific package, or through another update mechanism. In some embodiments, the mobile device may verify a version, signature, hash, or other integrity indicator before using an updated spatial index package.

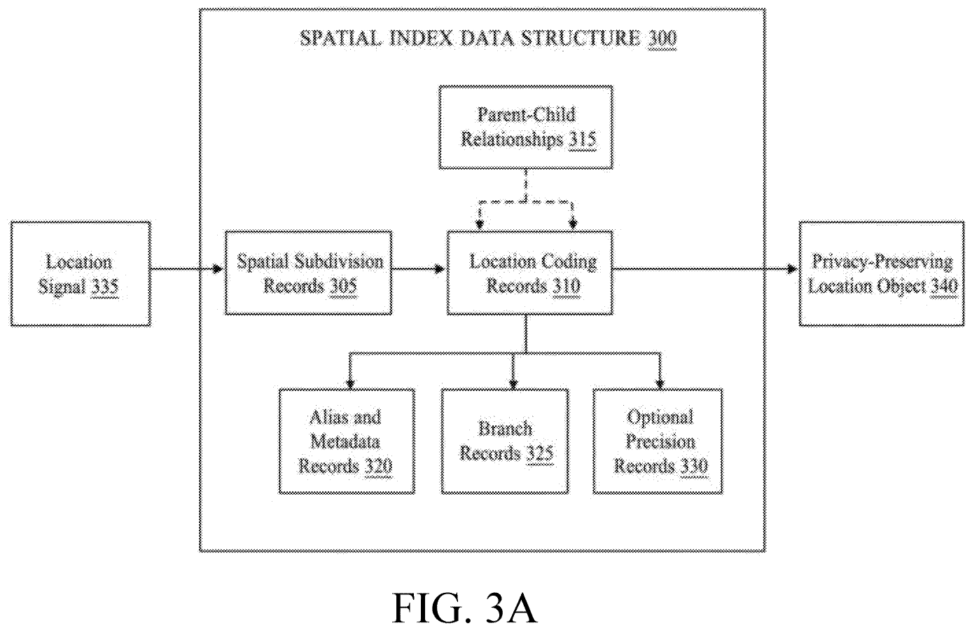

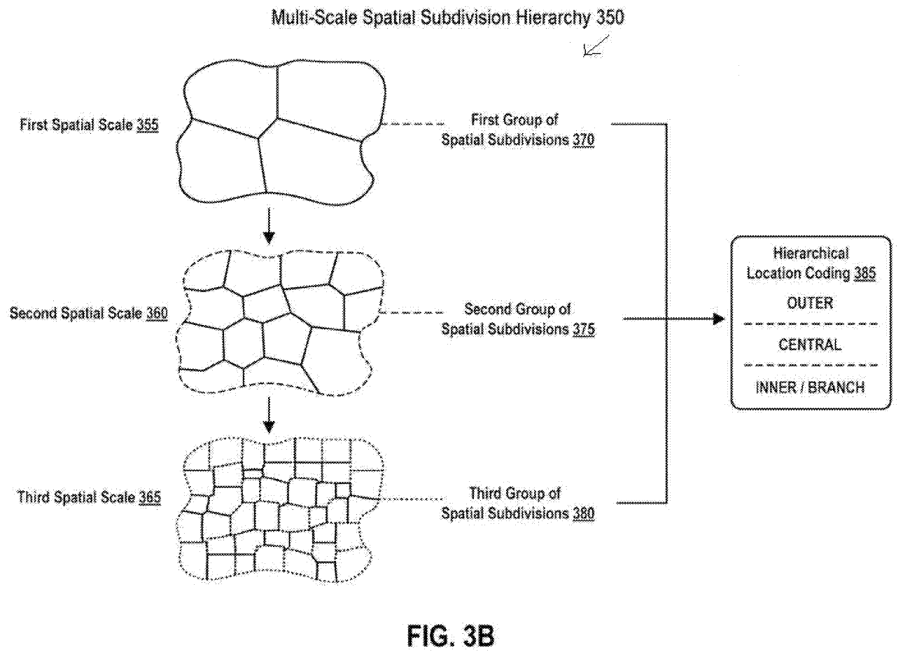

FIG. 3A illustrates an example spatial index data structure 300 for resolving location-related information into hierarchical location codings. The spatial index data structure 300 may be stored locally on a mobile device, partially stored locally and partially accessed from one or more remote resources, cached on a mobile device, distributed in one or more update packages, or otherwise maintained for use by a location coding process.

In one or more embodiments, the spatial index data structure 300 may include a plurality of spatial subdivision records 305. Each spatial subdivision record 305 may correspond to one or more cells, polygons, tiles, grid regions, hierarchical spatial identifiers, geohash-like identifiers, H3-like cells, S2-like cells, administrative regions, transportation regions, natural regions, event regions, water regions, or other spatial representations. A spatial subdivision record 305 may include or reference geometry information, containment information, parent-child relationships, adjacency information, centroid information, boundary information, representative cell information, resolution information, or other spatial information.

In some embodiments, the spatial index may use, adapt, map to, interoperate with, or be generated from one or more hierarchical grid systems, including H3-like, S2-like, geohash-like, tile-based, polygon-based, or other hierarchical spatial frameworks, without requiring the stored location coding hierarchy to match the native hierarchy of any particular underlying grid system.

The spatial index data structure 300 may map spatial subdivision records 305 to one or more location coding records 310. Each location coding record 310 may include one or more hierarchical location elements, such as a continent identifier, country identifier, regional identifier, local identifier, transportation hub identifier, time zone identifier, branch identifier, event identifier, ocean identifier, sea identifier, water-region identifier, optional precision descriptor, or other location-related identifier. In some embodiments, multiple spatial subdivision records 305 may map to the same location coding record 310. In other embodiments, a single spatial subdivision record 305 may map to multiple candidate location coding records 310 at different levels of detail or in different coding contexts.

In certain embodiments, the spatial index data structure 300 may include parent-child relationships 315 among location coding records 310. For example, a local identifier may be associated with a regional identifier, country identifier, continent identifier, and time zone identifier. A branch identifier may be associated with a parent local identifier, regional identifier, country identifier, transportation hub identifier, event identifier, water-region identifier, or other parent location identifier. The parent-child relationships 315 may allow the mobile device to generate hierarchical location codings at different levels of precision or to determine whether two coded location objects correspond to the same or related geographic areas.

In one or more embodiments, a location coding record, spatial subdivision record, branch record, or other location-related record may be associated with one parent identifier, multiple parent identifiers, one or more parallel grouping identifiers, or combinations thereof. For example, a location-related record may be associated with multiple broader geographic, administrative, temporal, cultural, transportation, time-zone, water-region, event-region, or other contextual groupings. Such associations need not form a strict single-parent tree and may instead form a graph, directed acyclic graph, multi-parent hierarchy, faceted classification, or other relationship structure.

In some embodiments, a broader location identifier may be associated with multiple parent groupings, while a more specific spatial subdivision or child location identifier may be associated with only one of those parent groupings for a particular location signal. For example, a region, locality, destination area, park, transportation hub, or other location identifier may overlap or be associated with multiple parent contexts, while a particular coordinate, cell, branch, or subregion resolved from a location signal may correspond to a selected parent context based on containment, boundary rules, ranking, user context, time-zone rules, administrative data, or other disambiguation logic. In other embodiments, overlapping or ambiguous cases may be preserved as multiple candidate parent relationships, presented for user confirmation, ranked by confidence, or represented using multiple parallel grouping identifiers.

In certain embodiments, time-zone identifiers, language-region identifiers, market-region identifiers, network-region identifiers, water-region identifiers, or other contextual identifiers may be treated as parallel attributes or grouping clusters rather than strict hierarchical parents.

The spatial index data structure 300 may also include alias and metadata records 320. Alias and metadata records 320 may include alternative names, abbreviations, transportation codes, airport codes, local codes, region names, country names, event names, venue names, landmark names, body-of-water names, search terms, display names, language-specific labels, popularity indicators, ranking information, time zone information, travel-related metadata, or other information usable to resolve, rank, search, display, or disambiguate location codings. In some embodiments, alias and metadata records 320 may allow the mobile device to match calendar text, user-entered text, travel-record text, ticket text, image-derived text, peer-shared text, or other location-related data to one or more location coding records 310.

In one or more embodiments, the spatial index data structure 300 may include branch records 325. A branch record 325 may identify a subregion associated with a parent location identifier. For example, a branch record 325 may correspond to a portion, sector, neighborhood, park area, island area, landmark area, transportation area, event area, venue area, or other subregion within or associated with a parent location identifier. A branch record 325 may include a branch identifier, parent location identifier, representative cells, simplified boundary, inherited boundary reference, centroid, bounding region, alias metadata, optional precision metadata, or other information. In some embodiments, a branch identifier may be unique within the corresponding parent location identifier rather than globally unique.

The spatial index data structure 300 may further include optional precision records 330. Optional precision records 330 may correspond to venues, points of interest, landmarks, buildings, terminals, gates, resorts, attractions, event spaces, custom labels, user-entered descriptions, or other more specific location details. In some embodiments, optional precision records 330 may be stored separately from a base spatial index, downloaded for selected regions, cached temporarily, encrypted, recipient-specific, or omitted from shared payloads unless authorized by the user. Optional precision records 330 may allow the system to provide additional detail while preserving a default coarse location coding.

In certain embodiments, the spatial index data structure 300 may be reduced in scope or level of detail relative to a full geographic, mapping, address, or point-of-interest database. For example, the spatial index data structure 300 may omit at least some street-level, parcel-level, building-level, or fine-grained point-of-interest data. The spatial index data structure 300 may instead focus on location codings useful for travel, social coordination, itinerary composition, event participation, or user-controlled sharing. In some embodiments, the spatial index data structure 300 may include a global coarse index and one or more optional regional, city-level, event-level, body-of-water, branch-level, or precision-level packages.

In use, the mobile device may receive or derive a location signal 335 and determine one or more corresponding spatial subdivision records 305. The mobile device may then use mappings within the spatial index data structure 300 to identify one or more candidate location coding records 310. Where multiple candidate location coding records 310 are identified, the mobile device may use alias and metadata records 320, parent-child relationships 315, branch records 325, optional precision records 330, user context, calendar context, device context, confidence information, or other factors to select, rank, or present one or more location codings. A selected location coding may then be used to generate a privacy-preserving location object 340.

Although FIG. 3A illustrates one example organization of a spatial index data structure, other data structures may be used. For example, spatial subdivision records, location coding records, metadata records, branch records, optional precision records, and parent-child relationships may be stored in separate tables, combined records, graph structures, trees, key-value stores, databases, serialized files, compressed packages, encrypted packages, or other data formats. The particular arrangement shown in FIG. 3A is merely illustrative.

In one or more embodiments, the spatial index may represent geographic areas using spatial subdivisions having different sizes, shapes, resolutions, or boundary geometries at different hierarchical levels. For example, a broader level may group relatively large spatial cells or regions to represent a continent, country, ocean region, travel region, or other high-level area, while one or more lower levels may use smaller cells, polygons, branches, or representative subdivisions to distinguish regions, localities, destination areas, transportation hubs, event areas, or optional precision areas. Different geographic areas need not use the same subdivision size, shape, or hierarchy, and the spatial index may use irregular, non-administrative, or travel-relevant groupings where useful for disambiguation, compression, privacy, or human-recognizable location coding.

FIG. 3B illustrates an example multi-scale spatial subdivision hierarchy 350 that may be used in connection with one or more spatial indexes described herein. As shown, the hierarchy 350 may include a first spatial scale 355, a second spatial scale 360, and a third spatial scale 365. The first, second, and third spatial scales 355, 360, 365 may correspond to different relative levels of geographic or travel-relevant resolution, rather than to fixed administrative categories that must be applied uniformly across all geographic areas.

In one or more embodiments, the first, second, and third spatial scales 355, 360, 365 may correspond to relative scale levels within a country, territory, land region, island region, metropolitan region, travel region, or other comparable parent context. Broader contextual identifiers, such as continent identifiers, country identifiers, time-zone identifiers, ocean identifiers, sea identifiers, or water-region identifiers, may be maintained separately from, above, parallel to, or in association with the relative scale levels shown in FIG. 3B.

In one example, the first spatial scale 355 may correspond to an outer level within a country or comparable parent context, such as a state, province, territory, district, island group, metropolitan region, travel corridor, regional destination area, or other broad within-country area. The second spatial scale 360 may correspond to a central level, such as a settlement, city, municipality, transportation hub, destination area, large event area, island, large park or natural feature, or other significant human-recognizable locality. The third spatial scale 365 may correspond to an inner level, such as a subregion, branch region, neighborhood, venue area, terminal area, attraction area, smaller settlement, or other more specific location within or associated with the central level.

The same terms need not map to the same physical size, population range, administrative class, or boundary type across different countries or parent contexts. For example, a metropolitan code may represent the most recognizable central location for one region, while a smaller town, island, transportation hub, or destination area may serve the central-level function in another region.

As further shown in FIG. 3B, the hierarchy 350 need not use uniformly sized or uniformly shaped cells at each level. For example, a first group of spatial subdivisions (group 370) may represent a broad area using relatively large cells, polygons, grid regions, tile regions, irregular regions, or other spatial subdivisions. A second group of spatial subdivisions (group 375) may represent an intermediate area using smaller, denser, differently shaped, or differently bounded subdivisions. A third group of spatial subdivisions (group 380) may represent a local, branch, or optional precision area using still smaller subdivisions, representative subdivisions, simplified polygons, or other compact spatial representations. In some embodiments, different geographic areas may use different subdivision sizes, shapes, densities, or boundary geometries depending on population distribution, transportation patterns, administrative structure, island structure, event boundaries, data availability, storage limitations, privacy settings, or other factors.

In certain embodiments, the spatial subdivision hierarchy 350 may be used to generate one or more hierarchical location codings 385. For example, a location coding 385 may include an outer, regional, or broader identifier derived from the first spatial scale 355, a central, local, or locality-level identifier derived from the second spatial scale 360, and an inner, branch, or precision-related identifier derived from the third spatial scale 365. In other embodiments, one or more of these levels may be omitted, combined, represented by a single internal identifier, or replaced with another level where appropriate for a particular geography or use case. Thus, the hierarchy 350 may support coarse, human-recognizable, privacy-preserving location codings without requiring all regions to follow the same country-region-city structure.

In one or more embodiments, the spatial subdivision hierarchy 350 may be generated, updated, validated, or maintained using one or more automated software agents, artificial-intelligence-assisted agents, large-language-model-based agents, machine-learning systems, rule-based software processes, data-validation processes, human-assisted review systems, or combinations thereof. For example, such systems may identify candidate spatial subdivisions, detect inconsistent or stale boundaries, compare aliases or place names, validate parent-child relationships, propose changes to one or more subdivision groups (e.g., group 370, group 375, group 380), or generate update packages for mobile devices. In some embodiments, updates to the hierarchy 350 or to a spatial index derived therefrom may be associated with version identifiers, audit logs, change records, ledger records, signatures, hashes, timestamps, reviewer identifiers, agent identifiers, or other provenance information.

Although FIG. 3B illustrates three relative spatial scales for clarity, the hierarchy 350 is not limited to exactly three levels in all embodiments. In some embodiments, up to three within-country or within-parent relative scale levels may be used as a practical target for generating compact, human-recognizable location codings that progress from a broader outer context, to a central recognizable locality, to an inner or branch-level location where additional disambiguation is useful. In other embodiments, fewer levels may be sufficient, one or more levels may be omitted, or additional levels may be used for particular geographies, water regions, event regions, transportation systems, optional precision records, or implementation-specific requirements. Likewise, the spatial subdivisions shown in FIG. 3B are merely illustrative, and may comprise cells, polygons, grid regions, hierarchical spatial identifiers, geohash-like regions, H3-like cells, S2-like cells, tile regions, administrative regions, transportation regions, event regions, body-of-water regions, branch regions, or other spatial representations. The spatial subdivision hierarchy 350 may be used alone or in combination with the spatial index data structure 300, procedures 400 and 1100, and any other embodiment described herein.

### Branch Identifiers and Optional Precision Descriptors

In one or more embodiments, a location coding may include a branch identifier associated with a portion, sector, subregion, landmark area, venue area, neighborhood, park area, island area, transportation area, event area, or other area within or associated with a broader location identifier. A branch identifier may be used, for example, to provide a more specific location reference within a local code, regional code, country code, body-of-water code, or other parent location identifier without requiring the system to assign or distribute a separate primary location code for every smaller place, venue, municipality, neighborhood, or point of interest.

A branch identifier may be generated, selected, or assigned in any suitable manner. In some embodiments, a branch identifier may be derived at least in part from one or more spatial subdivisions associated with the branch. For example, a branch identifier may be generated from a selected set of cells, polygons, grid regions, tile identifiers, or other spatial subdivisions that are associated with a subregion and are distinguishable from other subregions within the same parent location identifier. In certain embodiments, a branch identifier may be a stable alphanumeric identifier generated from a sample, hash, encoding, ordering, or other transformation of one or more spatial subdivision identifiers. In other embodiments, a branch identifier may be assigned by an operator, derived from a landmark, event, venue, organization, transportation feature, geographic feature, or other source, or selected to be human-readable, compact, unique within a parent region, or otherwise suitable for display or communication. That is, in other embodiments, a branch identifier may comprise or be associated with a human-recognizable name, label, alias, landmark name, venue name, event name, geographic name, or other descriptive identifier corresponding to the focus, contents, or commonly understood identity of the branch.

In certain embodiments, a branch identifier may be unique or disambiguating only within a corresponding parent location identifier, rather than globally unique. For example, a branch identifier may be interpreted together with a local code, region code, country code, ocean code, event code, or other parent identifier. This may reduce storage requirements, shorten displayed or transmitted codes, and allow different geographic areas to use similar branch formats without requiring a single global branch namespace. In some embodiments, a branch identifier may be generated or selected to remain stable across later refinement of the spatial index, including changes to grid resolution, boundary detail, metadata, aliases, or optional precision datasets.

A branch may be represented in the spatial index with varying degrees of boundary detail. In some embodiments, a branch may inherit one or more boundaries, edges, cells, or containment relationships from a parent location identifier or from existing spatial subdivisions, thereby reducing the amount of separate geometry that must be stored for the branch. In other embodiments, a branch may be represented by a centroid, bounding region, set of representative cells, simplified polygon, boundary reference, containment relationship, or other compact representation. Such representations may reduce storage requirements or processing complexity while still allowing the mobile device to associate a location signal with a branch-level location coding.

A location coding may also include one or more optional precision descriptors. An optional precision descriptor may identify, for example, a venue, point of interest, landmark, neighborhood, park, building, terminal, gate, resort, attraction, event space, custom label, user-entered description, or other more specific location detail. In some embodiments, optional precision descriptors may be appended to, associated with, or displayed alongside a coarse location coding without being required as part of the base spatial index. In this manner, a coarse location coding may provide a default level of location disclosure, while optional precision descriptors may be added, withheld, hidden, encrypted, time-limited, recipient-specific, or otherwise controlled by the user or application in general or conditionally for a subset of recipients.

In one example, a coded location object may include a local code corresponding to a city or travel hub and may further include a branch identifier corresponding to a subregion within that city or travel hub. The coded location object may optionally include a user-selected precision descriptor corresponding to a specific park, venue, event, hotel, restaurant, office, or other place. In another example, a coded location object may include a country or regional code and an optional descriptor corresponding to a national park, island, ski area, beach area, festival area, port, resort, theme park, or other travel-relevant area.

Optional precision descriptors may be obtained from or derived using any suitable source. For example, optional precision descriptors may be selected by a user, resolved from calendar text, extracted from travel reservations or scanned credentials, selected from local metadata, retrieved from a remote service, generated by a machine-learning model, inferred from user history, provided by an event organizer, associated with a sponsored region, or received from another user. In some embodiments, optional precision descriptors may be stored separately from the spatial index, downloaded only for selected areas, cached temporarily, encrypted for selected recipients, or omitted from shared payloads unless authorized.

In one or more embodiments, the system may apply precision rules to determine whether and how branch identifiers or optional precision descriptors are included in a coded location object, ticket-like object, itinerary segment, notification, or shared update. Such precision rules may be based on user selections, recipient identity, group membership, relationship type, time of day, event status, current or future location status, application mode, device state, privacy setting, or other contextual information. Thus, different recipients may receive different levels of location detail for the same underlying location-related event.

### Privacy-Preserving Location Objects

In one or more embodiments, the mobile device may generate a privacy-preserving location object based on a location coding resolved using the spatial index. The location object may provide a reusable data structure for representing a location-related state, update, plan, destination, itinerary segment, presence indication, group event, ticket payload, or other location-related item. In some embodiments, the location object may be generated entirely or partially on the mobile device and may be stored, displayed, encrypted, synchronized, transmitted, scanned, imported, or otherwise processed by one or more devices.

The location object may include one or more location coding elements, such as a continent identifier, country identifier, region identifier, local identifier, time zone identifier, branch identifier, ocean identifier, sea identifier, event identifier, ephemeral-region identifier, optional precision descriptor, or other location-related identifier. The location object may also include temporal information, such as a start time, end time, arrival time, departure time, expiration time, publication time, last-updated time, recurrence information, or confidence interval. In some embodiments, the location object may include source information indicating whether the location coding was derived from a device location signal, calendar entry, travel record, scanned credential, user selection, peer-shared object, detected motion event, imported image, or other source.

In certain embodiments, the location object may omit raw geographic coordinates, street addresses, or other fine-grained location information by default. For example, the location object may include a city-level, region-level, country-level, branch-level, or other coded representation of location information without including a latitude/longitude pair or precise address. In other embodiments, more precise information may be included only when selected by the user, permitted by a privacy setting, required by a selected workflow, encrypted for a particular recipient, or otherwise authorized. Thus, a single underlying location-related event may be represented at different levels of detail for different users, groups, interfaces, or sharing contexts.

The location object may further include visibility information or access-control information. For example, the location object may specify whether it is private, shared with selected contacts, shared with a group, shared with a public or semi-public profile, shared for a limited time, shared only after confirmation, shared only at a coarse level, or shared with different precision levels for different recipients. In some embodiments, the location object may include or reference one or more permission rules, recipient lists, group identifiers, relationship identifiers, cryptographic keys, encrypted payloads, signatures, nonces, revocation values, or expiration values.

In one or more embodiments, the location object may be protected before, during, or after transmission from the mobile device using transport encryption, end-to-end encryption, field-level or fractional encryption, signing, access-control rules, selective withholding of fields, recipient-specific payload generation, or combinations thereof. For example, all or a portion of the location object may be encrypted for just one or more selected recipients, groups, devices, accounts, public profiles, services, or organizations to be able to practically decrypt. A relay server, peer device, distributed service, or other intermediary may receive, store, forward, synchronize, or otherwise process a protected location object, ticket payload, message, or update without accessing one or more protected fields, withheld fields, unencrypted optional precision descriptors, or recipient-specific payload portions. In some embodiments, different portions of the location object may be encrypted differently, such that one recipient may receive a coarse location coding while another recipient receives a branch identifier or optional precision descriptor.

The location object may be mutable or immutable depending on context. For example, a location object stored on a user's own device may be editable, confirmable, suppressible, deletable, or updatable by the user. A copy of the location object received by another device may be immutable, partially mutable only for local annotations, or mutable only within permissions defined by the originating user. In some embodiments, updates to a location object may generate a new object version, replacement object, revocation message, expiration update, or differential update. Versioning may allow devices to determine whether a displayed ticket, itinerary segment, profile update, or shared location state is current, expired, superseded, or revoked.

A location object may also be used as a common primitive across multiple application features. For example, the same or related location object may be used to render a ticket-like interface, generate an itinerary segment, update a user profile, determine whether to prompt a user to share a travel update, display a group presence indication, search for contacts or groups associated with a location coding, trigger a travel-related offer, or validate access to shared information. In this manner, location-related information may be processed and reused consistently across different interfaces and workflows while maintaining user-controlled precision and visibility.

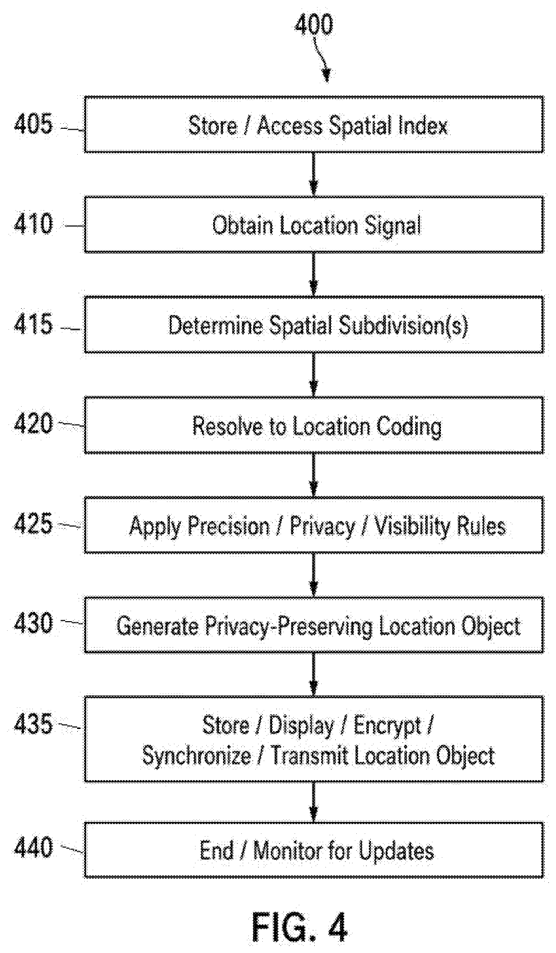

FIG. 4 illustrates an example procedure 400 for generating a privacy-preserving location object using a spatial index. Procedure 400 may be performed by a mobile device, by one or more processors of a mobile device, by an application executing on a mobile device, by a location coding process, by a distributed system including a mobile device and one or more servers, or by any other suitable device or combination of devices. The steps of procedure 400 are merely examples and may be reordered, combined, omitted, repeated, or supplemented in other embodiments.

At step 405, the mobile device stores, accesses, caches, or otherwise maintains a spatial index. The spatial index may be a reduced-scope, compressed, hierarchical, partially cached, or otherwise mobile-suitable data structure that maps spatial subdivisions to one or more location identifiers. In some embodiments, the spatial index may include a broad coarse index and one or more optional packages that provide additional detail for selected regions, events, branches, bodies of water, or other geographic areas.

At step 410, the mobile device obtains a location signal associated with a user, device, calendar entry, travel record, ticket-like object, peer-shared update, group event, or other location-related item. The location signal may include, for example, a device-derived coordinate, operating-system location output, wireless-network context, user-entered location string, calendar-derived location, scanned credential, imported image, message content, motion-derived travel signal, or other input.

At step 415, the mobile device determines one or more spatial subdivisions corresponding to the location signal. For example, the mobile device may determine one or more cells, polygons, grid regions, tile identifiers, hierarchical spatial identifiers, or other spatial subdivisions associated with the location signal. In some embodiments, this determination may be performed locally on the mobile device. In other embodiments, the determination may be supplemented by cached metadata, user confirmation, optional remote metadata, or other context.

At step 420, the mobile device resolves the one or more spatial subdivisions to a location coding using the spatial index. The location coding may include one or more hierarchical location elements, such as a country identifier, regional identifier, local identifier, transportation hub identifier, time zone identifier, branch identifier, event identifier, body-of-water identifier, optional precision descriptor, or other location-related identifier. Where multiple candidate location codings are available, the mobile device may rank, filter, select, or present the candidate location codings based on user context, calendar context, geographic context, confidence, visibility settings, travel mode, or other factors.

At step 425, the mobile device applies one or more precision, privacy, or visibility rules. For example, the mobile device may determine whether to include or omit a branch identifier, optional precision descriptor, street address, venue, point of interest, or other detailed information. The rules may be based on user selections, recipient identity, group membership, relationship type, sharing mode, application setting, event status, time range, date range, or other temporal range, or other context.

At step 430, the mobile device generates a privacy-preserving location object based on the location coding and the applicable rules. The location object may include coded location information, temporal information, source information, confidence information, display information, visibility settings, expiration information, cryptographic information, or other metadata. In certain embodiments, the location object may omit raw geographic coordinates or precise addresses unless such information is expressly selected, appended, encrypted, or otherwise authorized.

At step 435, the mobile device stores, displays, encrypts, synchronizes, transmits, or otherwise uses the location object. For example, the mobile device may display the location object in a ticket-like interface, associate the location object with a calendar-derived itinerary segment, transmit an encrypted version of the location object to selected recipients, use the location object to update a profile or presence indication, or compare the location object to another location object to determine whether to generate a prompt.

At step 440, the procedure may end, or the mobile device may continue to monitor for additional location signals, user selections, calendar changes, ticket interactions, motion-derived signals, group updates, revocation events, expiration events, or other inputs that may cause the location object to be updated, replaced, revoked, shared, suppressed, or otherwise modified.

### Ticket-Like Interfaces and Ticket Payloads

In one or more embodiments, a coded location object may be used to generate, update, display, share, import, or validate a ticket-like interface. The ticket-like interface may visually represent a current location, future destination, travel plan, itinerary segment, group plan, event presence, public profile update, or other location-related state. The ticket-like interface may resemble, evoke, or incorporate features of a travel ticket, boarding pass, event pass, access credential, collectible card, profile card, or other visual artifact, while serving as an application interface for presenting and interacting with coded location information.

The ticket-like interface may display one or more human-recognizable location identifiers derived from or associated with a coded location object. For example, the ticket-like interface may display a local code, transportation hub code, city code, region code, country code, branch identifier, event identifier, body-of-water identifier, or optional precision descriptor. In some embodiments, a most significant location identifier may be visually emphasized, such as through larger text, a prominent field, a destination field, a header, a central display area, a graphical stamp, or another visual treatment. Additional location coding elements, such as parent identifiers, time zone information, branch identifiers, optional precision descriptors, or sharing status, may be displayed, hidden, expanded, collapsed, encrypted, recipient-specific, or otherwise controlled according to application settings.

The ticket-like interface may also include time-related information, user-related information, group-related information, status information, or contextual information. For example, the ticket-like interface may include a date range, arrival time, departure time, expiration time, itinerary segment, profile name, avatar, group identifier, event identifier, sharing status, confirmation status, visibility indicator, prompt, instruction, decorative element, or other information. In some embodiments, the ticket-like interface may include one or more rows, fields, panels, tabs, stamps, badges, icons, avatars, map-like elements, spatial-grid representations, or other visual components associated with coded location objects or related application functions.

In certain embodiments, the ticket-like interface may include or be associated with a ticket payload. The ticket payload may comprise, for example, data corresponding to one or more coded location objects, profile identifiers, user identifiers, group identifiers, public profile identifiers, invitation identifiers, access scopes, visibility settings, precision settings, expiration values, nonces, revocation values, cryptographic signatures, encrypted payloads, or other information. The ticket payload may be stored locally, transmitted within an application, embedded into an exported image, encoded into a machine-readable element, referenced by a link, or otherwise associated with the ticket-like interface.

The ticket-like interface may include a machine-readable element, such as a barcode, QR code, two-dimensional code, visual pattern, watermark, steganographic marking, encoded text strip, glyph sequence, checksum, optical code, NFC-readable element, or other scannable, detectable, or importable element. The machine-readable element may encode the ticket payload directly or may encode a pointer, identifier, signature, or reference usable to retrieve, validate, decrypt, or interpret the ticket payload. In some embodiments, the machine-readable element may be configured to remain usable when the ticket-like interface is shared as an image, screenshot, animation, video frame, printout, message attachment, social media post, or other off-network artifact.

A ticket-like object may be shared or communicated in a variety of ways. For example, a user may share the ticket-like object within an application, export the ticket-like object as an image, post the ticket-like object to a social networking platform, send the ticket-like object through a messaging application, print the ticket-like object, display the ticket-like object on a device screen, or otherwise make the ticket-like object available to another user or device. A recipient device may scan the displayed ticket-like object using a camera, import the ticket-like object from a photo library, receive the ticket-like object as a file or message attachment, capture the ticket-like object from a screenshot, or otherwise obtain the ticket-like object.

Upon obtaining a ticket-like object, a recipient device may extract, decode, identify, or otherwise process the machine-readable element or ticket payload. The recipient device, an application executing on the recipient device, or a server may validate a signature, nonce, expiration value, revocation value, permission scope, account association, profile association, group association, or other ticket condition. Based on the validation, the recipient device may initiate a connection request, follow request, group-join request, itinerary-access request, plan-cloning workflow, ticket-redemption workflow, application onboarding workflow, profile-viewing workflow, or other controlled interaction.

In one or more embodiments, different ticket-like objects may be generated for different sharing contexts. For example, a private invitation ticket may allow a recipient to request a direct connection with the originating user. A public-follow ticket may allow a recipient to follow a public or semi-public profile without establishing a personal connection. A group ticket may allow a recipient to join or request access to a group, event, organization, fleet, team, trip, or channel. A plan ticket may allow a recipient to clone, join, express interest in, or search for travel options associated with a shared itinerary segment. A temporary ticket may expire after a selected time, after a selected number of scans, after a revocation event, or after a corresponding travel or event period.

In certain embodiments, a ticket-like interface may function as both a display interface and an interaction hub. For example, a user may select a field, row, location identifier, date range, avatar, group element, machine-readable element, status indicator, or other portion of the ticket-like interface to edit a location object, adjust visibility, change precision, confirm a destination, remove an itinerary segment, view a woven itinerary, browse another user's ticket, request access, join a group, clone a plan, view map-related information, or perform another application function. Thus, the ticket-like interface may be a visual representation of coded location information as well as an interactive control surface for downstream location-based workflows.

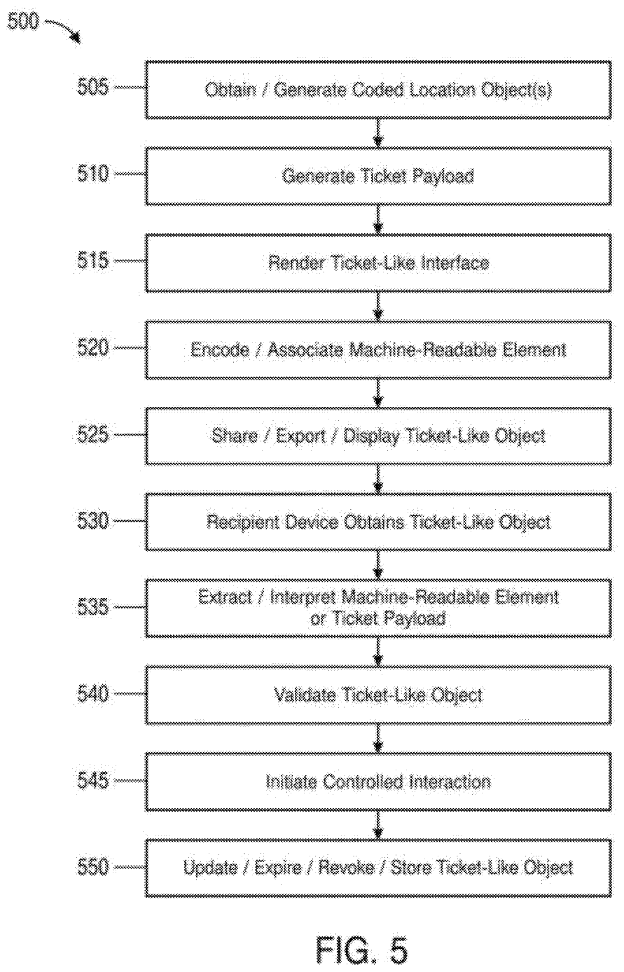

FIG. 5 illustrates an example procedure 500 for generating, sharing, importing, and validating a ticket-like object based on a coded location object. Procedure 500 may be performed by a mobile device, by one or more processors of a mobile device, by an application executing on a mobile device, by one or more servers, by a recipient device, or by any suitable combination of devices. The steps of procedure 500 are merely examples and may be reordered, combined, omitted, repeated, or supplemented in other embodiments.

At step 505, a mobile device obtains or generates one or more coded location objects. The coded location objects may correspond to a current location, future destination, destination block, itinerary segment, event presence, group plan, profile update, travel record, calendar-derived location, user-entered destination, scanned credential, or other location-related item.

At step 510, the mobile device generates a ticket payload based on the one or more coded location objects. The ticket payload may include one or more location codings, time ranges, profile identifiers, user identifiers, group identifiers, event identifiers, permission scopes, visibility settings, precision settings, expiration values, revocation values, nonces, cryptographic signatures, encrypted fields, or other information.

At step 515, the mobile device renders a ticket-like interface based on the ticket payload. The ticket-like interface may display a short-form location identifier, destination field, date range, user or profile information, group information, status information, optional precision descriptor, decorative element, map-like element, machine-readable element, or other visual component. In some embodiments, the ticket-like interface may be interactive and may allow the user to edit, confirm, suppress, share, revoke, expire, restyle, or otherwise manage one or more coded location objects or ticket fields.

At step 520, the mobile device encodes, embeds, associates, or displays a machine-readable element with the ticket-like interface. The machine-readable element may include, for example, a barcode, QR code, visual pattern, watermark, steganographic marking, encoded text strip, glyph sequence, optical code, link, or other scannable or importable element. The machine-readable element may encode the ticket payload directly or may encode a pointer, identifier, signature, or reference usable to retrieve, validate, decrypt, or interpret the ticket payload.

At step 525, the ticket-like object is shared, exported, transmitted, displayed, posted, printed, or otherwise made available to one or more recipients. For example, the ticket-like object may be shared within an application, exported as an image, sent through a messaging application, posted to an external social platform, displayed on a screen for scanning, saved to a photo library, attached to a message, or printed.

At step 530, a recipient device obtains the ticket-like object. For example, the recipient device may scan the ticket-like object using a camera, import the ticket-like object from a photo library, receive the ticket-like object as a message or message attachment, capture the ticket-like object from a screenshot, obtain the ticket-like object from a social media post, or otherwise receive the ticket-like object.

At step 535, the recipient device extracts or interprets the machine-readable element or ticket payload. For example, the recipient device may decode a barcode, QR code, visual pattern, encoded text strip, watermark, signature, identifier, link, or other machine-readable element. In some embodiments, the recipient device may retrieve additional payload information from a server, decrypt one or more encrypted fields, or request validation of one or more ticket conditions.

At step 540, the recipient device, originating device, or a server validates the ticket-like object. Validation may include checking a cryptographic signature, nonce, expiration value, revocation value, permission scope, user identifier, profile identifier, group identifier, access policy, scan count, geographic restriction, time restriction, or other ticket condition. In some embodiments, a validation request may be transmitted with ticket-related data while omitting raw geographic coordinates or unencrypted optional precision descriptors.

At step 545, based on the validation, the recipient device initiates one or more controlled interactions. For example, the recipient device may initiate a connection request, follow request, group-join request, itinerary-access request, plan-cloning workflow, profile-viewing workflow, onboarding workflow, ticket-redemption workflow, travel-search workflow, or other application workflow. In certain embodiments, the controlled interaction may provide access only to a coarse location coding, while access to branch identifiers, optional precision descriptors, future updates, group information, or other information may depend on further permissions.

At step 550, the ticket-like object may be updated, expired, revoked, stored, archived, collected, or associated with one or more local records. For example, the originating user may revoke or expire a ticket-like object after sharing it, the recipient may store the ticket-like object as a souvenir or reference, or the application may update the displayed ticket-like object when an underlying coded location object changes.

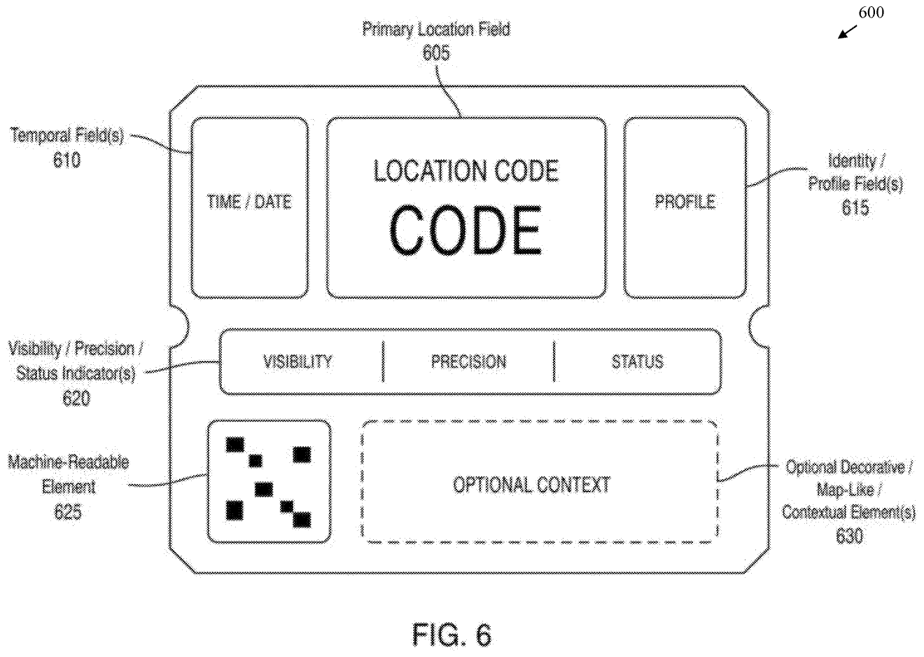

FIG. 6 illustrates an example ticket-like interface 600 for displaying and sharing location-related information. The ticket-like interface 600 may be generated based on one or more coded location objects and may visually represent a current location, future destination, travel plan, itinerary segment, event presence, group plan, public profile update, or other location-related state.

In one or more embodiments, the ticket-like interface 600 may include a primary location field 605. The primary location field 605 may display a short-form, human-recognizable location identifier derived from a coded location object, such as a city code, airport code, transportation hub code, region code, country code, branch identifier, event identifier, body-of-water identifier, or other location-related code. In some embodiments, the primary location field 605 may display the most significant location identifier for the ticket-like object, while additional location coding elements may be displayed in secondary fields, hidden, expanded upon selection, encrypted, or made visible only to selected recipients.

The ticket-like interface 600 may include one or more temporal fields 610. Temporal fields 610 may indicate, for example, a date range, arrival time, departure time, event time, expiration time, sharing period, itinerary segment time, or other time-related information. In some embodiments, temporal fields 610 may be derived from calendar entries, travel records, user input, ticket payloads, detected movement, or other sources.

The ticket-like interface 600 may include one or more identity or profile fields 615. For example, the interface may display a user name, profile name, avatar, group name, public profile name, organization name, event name, persona name, shared or calculated statistics, other non-current or scheduled locations (e.g., preferred, frequent, or past), contact information, web links, app shortcuts, or other identity-related information. In certain embodiments, the interface 600 may include selectable avatars or profile elements that allow a viewer to browse another user's ticket-like object, request a connection, follow a public profile, view a group ticket, or access a related itinerary segment.

The ticket-like interface 600 may include one or more visibility, precision, or status indicators 620. Such indicators may identify whether the displayed location information is private, shared, public, group-visible, tentative, confirmed, expired, revoked, coarse, branch-level, precision-enhanced, encrypted, or otherwise associated with a particular state. In some embodiments, a user may select one of the indicators 620 to adjust a visibility setting, precision setting, recipient list, expiration condition, revocation condition, or other attribute of the underlying coded location object or ticket payload.

The ticket-like interface 600 may include a machine-readable element 625. The machine-readable element 625 may comprise a QR code, barcode, visual pattern, watermark, encoded text strip, glyph sequence, steganographic marking, link, optical code, NFC-readable element, or other scannable, detectable, or importable element. The machine-readable element 625 may encode or reference a ticket payload associated with one or more coded location objects, permission scopes, cryptographic signatures, nonces, expiration values, revocation values, profile identifiers, group identifiers, or other information.

In one or more embodiments, the ticket-like interface 600 may be shared, exported, posted, sent, printed, displayed, scanned, imported, or otherwise communicated to another device. For example, the interface 600 may be exported as an image and sent through a messaging application, posted to a social media platform, saved to a photo library, displayed on a device screen for scanning, or imported from a screenshot. A recipient device may process the machine-readable element 625 to validate a ticket credential and initiate a controlled interaction, such as a connection request, follow request, group-join request, itinerary-access request, plan-cloning workflow, onboarding workflow, or profile-viewing workflow.

The ticket-like interface 600 may also include optional decorative, map-like, or contextual elements 630. Such elements may include stamps, badges, themes, colors, simulated materials, map backgrounds, spatial-grid representations, route indicators, event marks, achievement indicators, or other visual elements. These elements may be selected by a user, generated based on location coding, associated with a group or event, unlocked through activity, sponsored, purchased, or otherwise made available. In some embodiments, decorative elements 630 may be omitted from a claim implementation and may be provided as optional interface features.

Note that in one or more embodiments, off-network or cross-platform sharing of ticket-like objects may support an onboarding or propagation workflow. For example, a first user may generate a ticket-like object based on a coded location object, export or share the ticket-like object through a messaging service, social networking service, printed medium, website, or other channel, and cause a recipient device to import, scan, decode, or otherwise process the ticket-like object. The recipient device may then initiate application onboarding, profile access, group access, plan cloning, follow-request generation, connection-request generation, or generation of a new ticket-like object. In this manner, ticket-like objects may function as portable location-coded credentials that enable controlled interactions outside a native application channel while preserving validation, permission, revocation, or precision-control mechanisms.

### Calendar-Derived Itinerary Composition

In one or more embodiments, calendar entries, travel records, reservations, tickets, passes, messages, user-entered destinations, peer-shared updates, detected movement, or other location-related signals may be used to compose one or more destination blocks, itinerary segments, location updates, travel plans, or presence indications. Such signals may be obtained from an operating-system, calendar software, imported calendar feed, travel application, email account, messaging application, photo library, scanned credential, user input, previously composed or received update, or other suitable source, subject to user permissions and applicable privacy settings.

A calendar entry or other travel-related signal may include a location string, destination name, event name, venue name, transportation identifier, airport code, lodging reference, address, city, region, country, time zone, date range, start time, end time, recurrence pattern, attendee information, or other contextual information. The mobile device may process the signal to identify one or more candidate locations and may resolve the candidate locations using the spatial index to generate one or more coded location objects. In certain embodiments, the device may perform this resolution locally using the spatial index, alone or in combination with user confirmation, cached metadata, optional remote metadata, or other contextual information.

In one or more embodiments, a destination block or itinerary segment may be generated based on a coded location object and associated temporal information. For example, a destination block may represent that a user is expected to be in, traveling to, arriving at, departing from, attending an event in, or otherwise associated with a coded location during a particular temporal range (e.g., time range, date range, or other temporal range). Destination blocks may be generated automatically, semi-automatically, or manually, and may be maintained in draft, tentative, private, confirmed, shared, public, expired, revoked, or other states.

The system may organize destination blocks or itinerary segments according to time, location coding, user identity, group identity, sharing status, confidence, source, priority, or other contextual information. In some embodiments, the system may maintain a chronological index associated with time ranges and a spatial index associated with location codings. The chronological index and spatial index may be used together to cluster, sort, filter, display, compare, or update destination blocks. For example, multiple calendar entries may be clustered into a single destination block when they occur within a common time range and resolve to the same or related location coding. Conversely, a single calendar entry or travel record may generate multiple destination blocks when it indicates multiple meaningful locations, such as an origin, layover, destination, lodging area, venue, or event area.

In certain embodiments, the system may compare a calendar-derived candidate location with one or more existing coded location objects to determine whether a new destination block should be generated, an existing destination block should be extended, a prompt should be displayed, or no action should be taken. Such comparison may be based on one or more coding levels, such as country, region, local, branch, time zone, body-of-water, event, or optional precision levels. For example, a candidate calendar entry that resolves to the same local code as an existing destination block may be grouped with the existing destination block, while a candidate calendar entry that resolves to a different local code, region code, or country code may generate a new destination block or prompt for user confirmation.

The system may also determine whether a destination block is shared, unshared, partially shared, stale, expired, tentative, or inconsistent with other signals. For example, a future calendar entry may resolve to a coded location that is not currently shared with any contact or group. The mobile device may present a prompt suggesting that the user compose, confirm, share, suppress, or ignore an update associated with that coded location. In another example, a detected movement signal may indicate that a user has arrived in or departed from a coded location associated with a future or current calendar entry, and the mobile device may update the state of a destination block or prompt the user to confirm the state.

Destination blocks or itinerary segments may be displayed in any suitable interface. In one example, the system may display a calendar-augmented itinerary interface including rows, cards, timeline elements, map-related elements, ticket fields, user avatars, group indicators, draft indicators, confirmation indicators, sharing indicators, or other visual components. In another example, a destination block may appear as a row or field within a ticket-like interface. In another example, destination blocks associated with multiple users may be arranged into a woven itinerary interface showing overlapping or related presence at one or more coded locations over time.

In one or more embodiments, a user may interact with a destination block or itinerary segment to adjust a time range, select a location coding, add or remove an optional precision descriptor, change a visibility setting, confirm or reject an inferred destination, merge or split destination blocks, share the destination block with selected recipients, generate a ticket-like object, clone or join another user's plan, or perform another workflow. Different destination blocks may be associated with different precision levels or visibility rules, allowing a user to share a general location with one group while sharing a more specific branch or optional precision descriptor with another group.

In some embodiments, the system may limit processing or display to future or active location-related items, while omitting or de-emphasizing past items except for continuity, history, travel memory, analytics, scrapbook, souvenir, or user-requested functions. In other embodiments, past destination blocks or ticket-like objects may be stored, archived, collected, displayed, searched, exported, or used to generate travel histories, portfolios, scrapbooks, achievements, recommendations, or other optional features.

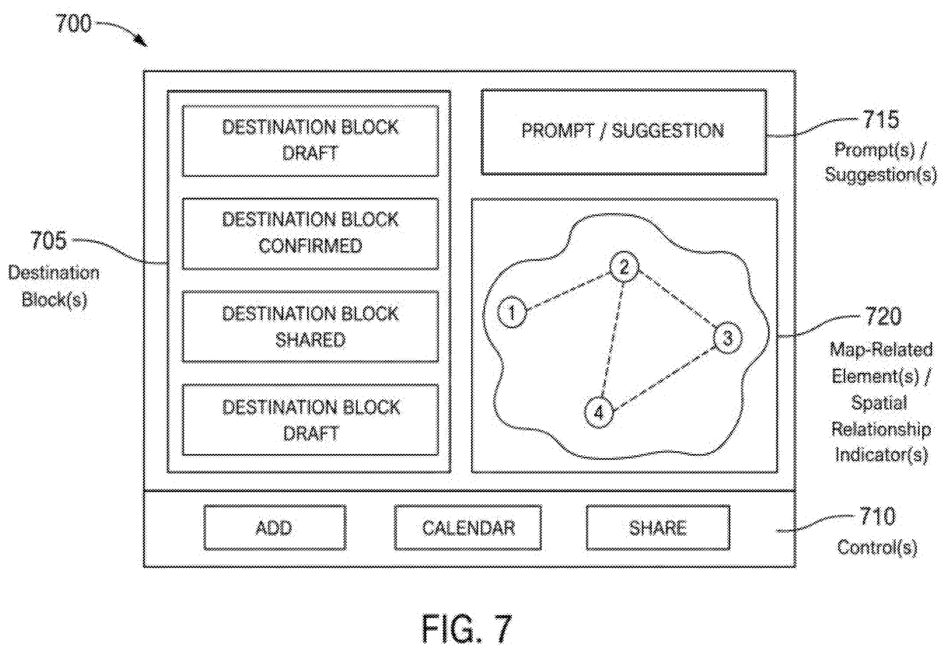

FIG. 7 illustrates an example calendar-augmented itinerary interface 700 in which one or more destination blocks or itinerary segments may be generated, organized, displayed, confirmed, shared, or otherwise managed using coded location objects. The interface 700 may be displayed on a mobile device, tablet, desktop device, wearable device, or other computing device, and may be generated by an application configured to process calendar-derived, travel-derived, user-entered, ticket-derived, peer-shared, or motion-derived location signals.

In one or more embodiments, the interface 700 may include one or more destination blocks 705. Each destination block 705 may correspond to a coded location object associated with a time range. For example, a destination block 705 may represent a current location, future destination, planned arrival, planned departure, event presence, lodging area, transportation hub, group plan, or other location-related state. A destination block 705 may include one or more location coding elements, such as a country identifier, region identifier, local identifier, transportation hub identifier, branch identifier, event identifier, body-of-water identifier, time zone identifier, or optional precision descriptor.

The interface 700 may arrange destination blocks 705 according to temporal information, location coding information, sharing status, user identity, group identity, confidence, source, or other contextual information. For example, the interface 700 may present destination blocks 705 in chronological order, grouped by location coding, grouped by overlapping time ranges, grouped by shared parent location identifiers, grouped by user or group, or organized as a woven itinerary showing overlapping destination blocks for multiple users. In some embodiments, the interface 700 may include rows, columns, cards, tickets, timeline elements, map-related elements, avatars, group indicators, or other visual components.

In certain embodiments, destination blocks 705 may be visually distinguished based on state. For example, a destination block may be displayed as draft, tentative, private, confirmed, shared, public, expired, revoked, stale, inconsistent, or awaiting user confirmation. The interface 700 may use different colors, icons, labels, opacity levels, borders, animations, or other visual treatments to distinguish such states. In one example, a calendar-derived destination block that has not yet been confirmed or shared may be displayed differently than a destination block that has been confirmed and shared with selected recipients.

The interface 700 may include one or more controls 710 for interacting with destination blocks 705. For example, a user may select a destination block 705 to confirm, edit, merge, split, share, suppress, delete, revoke, expire, restyle, clone, join, or otherwise modify the destination block. The user may also adjust a time range, location coding, branch identifier, optional precision descriptor, visibility setting, recipient list, group selection, sharing mode, ticket field, or other attribute associated with the destination block.

In one or more embodiments, the interface 700 may display destination blocks generated from multiple sources. For example, a first destination block may be generated from a calendar entry, a second destination block may be generated from a scanned travel credential, a third destination block may be generated from a motion-derived travel signal, and a fourth destination block may be generated from a peer-shared ticket-like object. The system may resolve each source to a coded location object using the spatial index and may organize the resulting destination blocks according to time, location coding, and user-controlled visibility settings.

The interface 700 may also present prompts or suggestions 715. For example, the interface 700 may identify that a calendar-derived destination block is private or unshared and may suggest that the user compose a ticket-like update. In another example, the interface 700 may identify that multiple users have destination blocks associated with the same or related coded location during overlapping time ranges and may suggest a group view, connection, shared plan, or itinerary action. In another example, the interface 700 may suggest that the user suppress a destination block, adjust a precision level, or confirm that a detected travel event corresponds to a scheduled destination.

In some embodiments, the interface 700 may include map-related elements, path elements, or spatial relationship indicators 720. Such elements may be generated from coded location objects rather than requiring display or sharing of precise coordinates. For example, the interface 700 may display a generalized path between coded location identifiers, a dotted line corresponding to a tentative or suggested destination, a solid line corresponding to a confirmed transition, or a simplified map region associated with one or more coded location objects. The level of detail displayed may be based on the user's precision settings, local device data, recipient permissions, or application context.

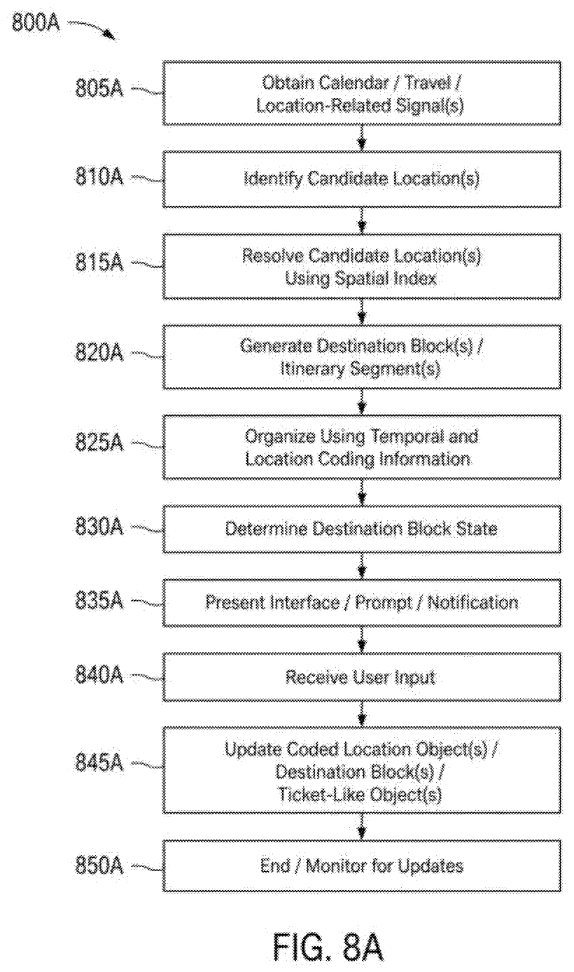

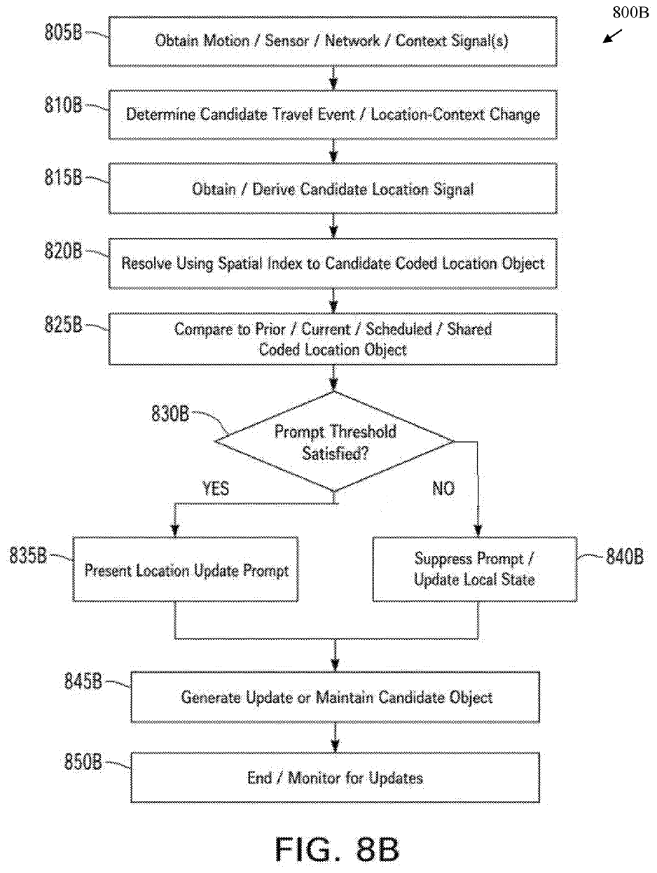

FIG. 8A illustrates an example procedure 800A for composing, confirming, sharing, or suppressing location updates based on calendar-derived, travel-derived, user-entered, peer-shared, or other location-related signals. Procedure 800A may be performed by a mobile device, by one or more processors of a mobile device, by an application executing on a mobile device, by one or more servers, or by any suitable combination of devices. The steps of procedure 800A are merely examples and may be reordered, combined, omitted, repeated, or supplemented in other embodiments.

At step 805A, the mobile device obtains one or more calendar entries, travel records, reservations, tickets, passes, messages, peer updates, user-entered destinations, or other location-related signals. Such information may be obtained from an operating-system calendar, application calendar, imported calendar feed, travel application, email account, messaging application, photo library, scanned credential, user input, peer-shared update, group update, or other suitable source, subject to user permissions and applicable privacy settings.

At step 810A, the mobile device identifies one or more candidate locations from the obtained information. For example, the mobile device may identify a location string, destination name, event name, venue name, transportation identifier, airport code, lodging reference, address, city, region, country, time zone, date range, start time, end time, attendee reference, or other contextual information that may correspond to a location-related item.

At step 815A, the mobile device resolves the one or more candidate locations using the spatial index to generate one or more coded location objects. In certain embodiments, the resolution may be performed locally using the spatial index. In other embodiments, local resolution may be supplemented by cached metadata, optional remote metadata, user confirmation, calendar context, travel context, or other information.

At step 820A, the mobile device generates one or more destination blocks or itinerary segments based on the coded location objects and associated temporal information. A destination block or itinerary segment may represent that a user is expected to be in, traveling to, arriving at, departing from, attending an event in, or otherwise associated with a coded location during a particular time range.

At step 825A, the mobile device organizes the destination blocks or itinerary segments using temporal information and location coding information. For example, the mobile device may cluster, merge, split, sort, filter, or arrange destination blocks based on overlapping or adjacent time ranges, shared parent location identifiers, matching local identifiers, branch identifiers, time zone identifiers, event identifiers, group membership, sharing status, confidence, or other contextual information.

At step 830A, the mobile device determines a state of one or more destination blocks or itinerary segments. For example, a destination block may be designated as draft, tentative, private, confirmed, shared, public, expired, revoked, stale, inconsistent, or otherwise associated with a state. In some embodiments, the state may be based on whether the user has confirmed the destination block, whether the destination block has been shared, whether related motion-derived signals have been detected, whether a related ticket-like object has been generated, or whether a corresponding time range has elapsed.

At step 835A, the mobile device presents an itinerary interface, ticket-like interface, prompt, notification, or other output associated with one or more destination blocks. For example, the mobile device may display a destination block as a row in an itinerary interface, a field in a ticket-like interface, a timeline element, a map-related element, a profile update, a group update, or another visual component. The displayed information may be based on visibility settings, precision settings, user context, recipient context, group settings, or other factors.

At step 840A, the mobile device receives a user input associated with one or more destination blocks. For example, the user may confirm, edit, merge, split, share, suppress, delete, revoke, expire, restyle, clone, join, or otherwise modify a destination block, coded location object, itinerary segment, or ticket-like object. The user may also adjust a time range, location coding, optional precision descriptor, visibility setting, recipient list, group selection, or sharing mode.

At step 845A, the mobile device updates one or more coded location objects, destination blocks, itinerary segments, ticket-like objects, or shared updates based on the user input. For example, the mobile device may generate an encrypted update for selected recipients, update a local ticket-like interface, change a destination block from draft to confirmed, suppress a prompt, generate a group update, or create a new ticket-like object.

At step 850A, procedure 800A may end, or the mobile device may continue to monitor for calendar changes, travel-record changes, peer updates, ticket interactions, expiration events, revocation events, user inputs, or other information that may cause one or more destination blocks, coded location objects, itinerary segments, or ticket-like objects to be updated.

### Motion-Derived Travel Signals and Location Update Prompts

In one or more embodiments, a mobile device may use one or more motion-derived, sensor-derived, network-derived, operating-system-derived, or context-derived signals as inputs to a location coding or location update workflow. For example, a mobile device may detect or infer a travel event, arrival event, departure event, transportation mode, route change, stationary period, movement pattern, time zone change, network change, wireless environment change, or other context suggesting that a user may be associated with a new or changed location.

Such signals may be obtained from or based on any suitable source, including a satellite-based positioning receiver, inertial measurement unit, accelerometer, gyroscope, magnetometer, barometer, altimeter, wireless network information, cellular network information, Bluetooth or NFC interactions, operating-system activity classification, vehicle connection status, airplane-mode status, calendar information, travel records, scanned passes, user input, peer updates, or other information. In some embodiments, these signals may be used without continuously tracking or sharing a precise real-time position of the user.

A motion-derived or context-derived signal may trigger the mobile device to generate, update, compare, confirm, or suppress one or more coded location objects. For example, after detecting a travel event or potential arrival event, the mobile device may obtain or derive a candidate location signal and resolve the candidate location signal using the spatial index. The mobile device may then compare a candidate coded location object to one or more prior, current, scheduled, or shared coded location objects to determine whether a meaningful location transition has occurred.

In one or more embodiments, the comparison may be performed at one or more levels of a location coding hierarchy. For example, the mobile device may compare country identifiers, region identifiers, local identifiers, transportation hub identifiers, branch identifiers, body-of-water identifiers, time zone identifiers, event identifiers, optional precision descriptors, or other coding elements. If the candidate coded location object differs from a prior or scheduled coded location object at a selected threshold level, the mobile device may present a prompt requesting that the user confirm, edit, share, suppress, or ignore a location update. If the candidate coded location object does not differ at the selected threshold level, the mobile device may suppress the prompt, merge the signal into an existing destination block, or update a local state without generating a shareable update.

The threshold level may be selected based on user settings, application settings, recipient settings, group settings, device state, confidence, source type, travel mode, time of day, geographic context, calendar context, privacy mode, or other factors. For example, a user may configure the system to prompt only when the user crosses a local-code boundary, region-code boundary, country-code boundary, time-zone boundary, branch boundary, event-region boundary, or other boundary. In another example, the system may prompt differently depending on whether the detected movement corresponds to air travel, rail travel, driving, walking, boating, or another travel mode.

The system may also use coded location objects to tailor prompt content. For example, if a calendar-derived destination block already indicates that the user is expected to arrive at a coded location, the mobile device may present a confirmation prompt associated with the expected destination. If no corresponding destination block exists, the mobile device may present a more general prompt asking whether the user wishes to compose or share a new update. In some embodiments, prompts may include suggested recipients, suggested groups, suggested precision levels, suggested ticket fields, suggested times, dates, date ranges, time ranges, expiration periods, or suggested destination blocks based on the coded location object and related context.

In certain embodiments, motion-derived or context-derived signals may be used to maintain location-related information locally without automatically sharing that information. For example, the mobile device may update a private current coded location object, revise a draft destination block, mark an itinerary segment as arrived or departed, or update a ticket-like interface locally. Sharing may occur only after user confirmation, according to a previously defined sharing rule, or based on a user-selected automatic sharing setting.

In one or more embodiments, the system may combine motion-derived signals with calendar-derived, ticket-derived, user-entered, or peer-shared signals. For example, a calendar entry may identify an expected destination, a scanned boarding pass may identify an origin and destination, and a motion-derived signal may indicate that a corresponding travel event has occurred. The mobile device may resolve one or more of these signals into coded location objects and determine whether to generate a prompt, update an itinerary segment, display a ticket-like confirmation, or transmit an update to selected recipients.

FIG. 8B illustrates an example procedure 800B for generating, suppressing, or modifying location update prompts based on motion-derived or context-derived signals. Procedure 800B may be performed by a mobile device, by one or more processors of a mobile device, by an application executing on a mobile device, by one or more servers, or by any suitable combination of devices. The steps of procedure 800B are merely examples and may be reordered, combined, omitted, repeated, or supplemented in other embodiments.

At step 805B, the mobile device obtains one or more motion-derived, sensor-derived, network-derived, operating-system-derived, calendar-derived, travel-record-derived, or context-derived signals. Such signals may include accelerometer data, gyroscope data, barometer data, GPS data, operating-system activity classifications, airplane-mode status, wireless-network changes, cellular-network changes, Bluetooth or NFC interactions, vehicle connection status, time zone changes, calendar events, travel reservations, scanned credentials, peer updates, or other information.

At step 810B, the mobile device determines whether the one or more signals indicate a candidate travel event, arrival event, departure event, transportation event, stationary period, route change, location-context change, or other event that may be associated with a location update workflow. In some embodiments, this determination may be made without continuously sharing or transmitting a precise real-time position of the user.

At step 815B, in response to determining that a candidate event has occurred, the mobile device obtains or derives a candidate location signal. The candidate location signal may include a device-derived coordinate, operating-system location output, calendar-derived destination, travel-record-derived destination, scanned credential, user-entered location, peer-shared update, or other information.

At step 820B, the mobile device resolves the candidate location signal using the spatial index to generate a candidate coded location object. The candidate coded location object may include one or more hierarchical location coding elements, such as a country identifier, region identifier, local identifier, transportation hub identifier, time zone identifier, branch identifier, event identifier, body-of-water identifier, optional precision descriptor, or other location-related identifier.

At step 825B, the mobile device compares the candidate coded location object to one or more prior, current, scheduled, shared, or draft coded location objects. The comparison may be performed at one or more coding levels, such as country, region, local, transportation hub, branch, time zone, event, body-of-water, optional precision, or other coding levels. In some embodiments, the mobile device may compare the candidate coded location object to a calendar-derived destination block, a current private location object, a scheduled or previously shared location object, a group-visible location object, or another location object.

At step 830B, the mobile device determines whether the comparison satisfies a prompt threshold. The prompt threshold may be based on user settings, application settings, recipient settings, group settings, device state, confidence level, source type, travel mode, time of day, geographic context, calendar context, privacy mode, or other factors. For example, the prompt threshold may require a change in local code, region code, country code, time zone, branch identifier, event identifier, or other coding element before prompting the user.

At step 835B, when the prompt threshold is satisfied, the mobile device presents a prompt associated with the candidate coded location object. The prompt may ask the user to confirm, edit, share, suppress, ignore, revoke, expire, or otherwise manage a location update. In some embodiments, the prompt may include suggested recipients, groups, precision levels, time ranges, ticket fields, itinerary segments, visibility settings, or other suggested information based on the candidate coded location object and related context.

At step 840B, when the prompt threshold is not satisfied, the mobile device suppresses the prompt or updates a local state without generating a shared update. For example, the mobile device may merge the candidate coded location object into an existing destination block, update a private current location object, mark an itinerary segment as arrived or departed, update a ticket-like interface locally, or take no action.

At step 845B, the mobile device may receive user input or apply a preconfigured sharing rule to determine whether a location update should be generated. When a location update is generated, the mobile device may update a coded location object, destination block, itinerary segment, ticket-like object, profile indication, group update, or encrypted shared payload. When no location update is generated, the mobile device may maintain the candidate coded location object privately, discard the candidate coded location object, or store the candidate coded location object for later use.

At step 850B, procedure 800B may end, or the mobile device may continue to monitor for additional motion-derived signals, calendar changes, ticket interactions, expiration events, revocation events, user inputs, peer updates, or other information that may cause one or more coded location objects, destination blocks, itinerary segments, prompts, or ticket-like objects to be updated.

### Group, Public Profile, and Social Coordination Embodiments

In one or more embodiments, coded location objects, destination blocks, itinerary segments, ticket-like objects, or related location updates may be associated with one or more users, groups, organizations, public profiles, semi-public profiles, personas, events, trips, fleets, teams, channels, or other social coordination structures. A user may selectively share location-related information with individual contacts, contact groups, event groups, organizational groups, public followers, semi-public followers, or other recipients according to user-defined or application-defined visibility settings.

A group may be associated with one or more group-level ticket-like objects. A group-level ticket-like object may represent a trip, event, organization, team, travel cohort, public channel, private channel, fleet, family, friend group, fan profile, topic profile, or other collective context. In some embodiments, a group-level ticket-like object may include one or more coded location objects, destination blocks, time ranges, member indicators, group permissions, machine-readable elements, invitation payloads, public-follow credentials, private-access credentials, or other information. A recipient may scan, import, receive, or otherwise process the group-level ticket-like object to request access to the group, follow a public or semi-public group profile, view shared group updates, or participate in a shared itinerary.

Different users associated with a group may have different visibility settings. For example, a first user may share only a country-level or region-level location coding with a group, while a second user may share a local code, branch identifier, or optional precision descriptor. In another example, a user may share a current coded location object with one group and a future destination block with another group. Group members may be permitted to view, clone, join, comment on, react to, request access to, or otherwise interact with one or more destination blocks or ticket-like objects according to group rules and user permissions.

In certain embodiments, a system may generate or display a group itinerary, woven itinerary, or aggregated presence interface based on coded location objects associated with multiple users. For example, the system may determine that multiple users have destination blocks corresponding to the same local code, branch identifier, event identifier, region code, or other related location coding during overlapping or nearby time ranges. The system may display an aggregated view, notification, ticket field, group row, map-related element, or other interface indicating that the users may be associated with the same or related coded location during a relevant time period.

In some embodiments, a ticket-like interface may include selectable avatars, profile indicators, group indicators, or other user-related elements. Selecting such an element may cause the interface to display another user's ticket-like object, a public version of a profile, a group-level ticket, a shared itinerary segment, a mutual-location view, a connection request interface, a follow interface, or another related view. A received ticket-like object may be immutable or partially immutable with respect to the originating user's shared data, while allowing the recipient to add local annotations, reminders, grouping labels, or other private information.

The system may also support public, semi-public, or persona-based profiles. For example, a ticket-like object may be associated with a musician, athlete, public figure, creator, brand, event organizer, venue, team, organization, travel group, fan account, or topic-based profile rather than an individual personal account. Such a ticket-like object may allow users to follow public location updates, event presence, travel announcements, tour dates, group plans, or other location-coded information without requiring a personal connection to the originating account.

In one or more embodiments, social coordination may be performed without requiring a centralized server to access precise location content. For example, coded location objects and ticket payloads may be encrypted for selected recipients, groups, or public-profile access mechanisms. A server may relay, store, synchronize, validate, revoke, or index ticket-related metadata while being unable to access one or more encrypted location fields, optional precision descriptors, or recipient-specific payloads. In other embodiments, public or semi-public ticket payloads may include location codings at a deliberately coarse level while more detailed fields remain private, encrypted, omitted, or separately permissioned.

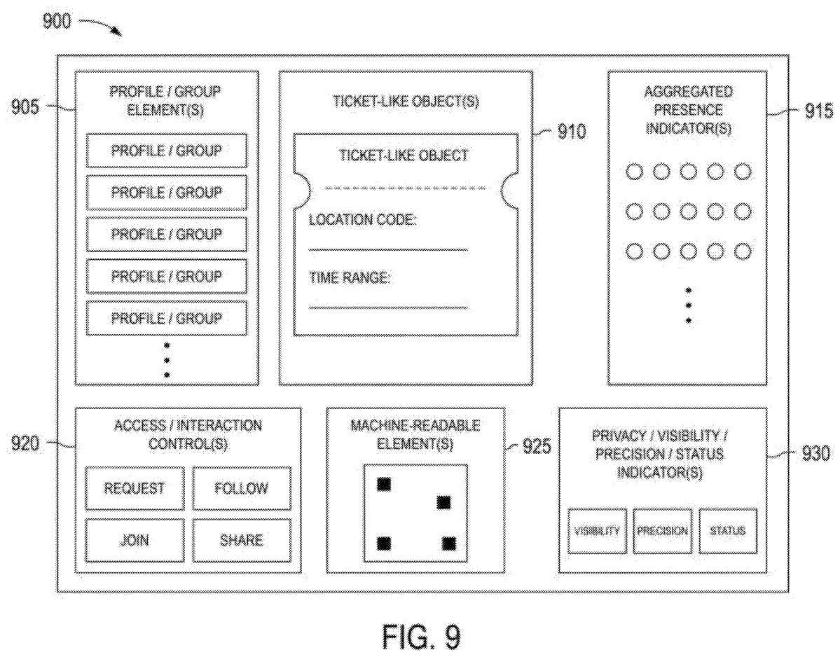

FIG. 9 illustrates an example group, public profile, or social coordination interface 900 using ticket-like objects and coded location updates. Interface 900 may be displayed on a mobile device, tablet, desktop device, wearable device, or other computing device, and may be generated by an application configured to manage coded location objects, ticket-like objects, destination blocks, itinerary segments, user profiles, group profiles, public profiles, semi-public profiles, or other location-related social coordination structures.

In one or more embodiments, interface 900 may include one or more profile or group elements 905. A profile or group element 905 may correspond to an individual user, contact, group, organization, public profile, semi-public profile, persona, event, trip, fleet, team, channel, venue, brand, creator, performer, or other entity. Each profile or group element 905 may be associated with one or more coded location objects, ticket-like objects, destination blocks, itinerary segments, visibility rules, access rules, or sharing preferences.

Interface 900 may display one or more ticket-like objects 910 associated with the selected profile or group element 905. A ticket-like object 910 may represent, for example, a current location update, future destination, public event presence, group itinerary segment, team travel plan, organization announcement, public-follow update, or other coded location state. In some embodiments, selecting a profile or group element 905 may cause the interface 900 to display a corresponding ticket-like object 910, public version of a ticket-like object, group-level ticket, shared itinerary, or related view.

In certain embodiments, interface 900 may include one or more aggregated presence indicators 915. Aggregated presence indicators 915 may be generated based on coded location objects associated with multiple users or profiles. For example, the application may determine that multiple users have destination blocks corresponding to the same or related location coding during overlapping or nearby time ranges. Interface 900 may then display an aggregated indication that one or more contacts, group members, public profiles, or event participants are associated with a particular local code, branch identifier, event identifier, region code, country code, or other location coding.

Interface 900 may also include one or more access or interaction controls 920. For example, a user may select a control 920 to request a connection, follow a profile, join a group, request access to a shared itinerary, clone a plan, join a travel plan, view a group ticket, send a message, adjust visibility, adjust precision, revoke access, expire a ticket, or otherwise interact with a profile, group, ticket-like object, coded location object, or destination block. In some embodiments, the controls 920 presented to a viewer may depend on ticket validation status, relationship status, group membership, public/private designation, permission scope, expiration status, revocation status, or other access-control information.

In one or more embodiments, interface 900 may include one or more machine-readable elements 925 associated with a profile, group, public ticket, private invitation, plan, event, or other social coordination structure. A machine-readable element 925 may encode or reference a ticket payload, public-follow credential, private connection invitation, group-access credential, event-access credential, plan-cloning credential, or other payload. Another device may scan or import the machine-readable element 925 to initiate a controlled interaction according to the associated permission scope.

In certain embodiments, interface 900 may present different levels of detail for different users, groups, or contexts. For example, a public viewer may see only a country-level, region-level, local-code-level, or event-level update, while an approved contact or group member may see a branch identifier, optional precision descriptor, time range, itinerary segment, or more detailed ticket field. Similarly, a user may share a current coded location object with one group, a future destination block with another group, and a public or semi-public ticket-like object with followers.

In some embodiments, interface 900 may display privacy, visibility, precision, confirmation, or status indicators 930. Such indicators may identify whether a ticket-like object or coded location object is private, public, group-visible, expired, revoked, confirmed, tentative, coarse, branch-level, precision-enhanced, encrypted, pending validation, awaiting confirmation, or otherwise associated with a particular state. A user may select one or more indicators 930 to modify settings or view additional information, subject to applicable permissions.

Interface 900 may also support decentralized, federated, external, or off-network sharing workflows. For example, a ticket-like object or profile ticket may be exported to another social platform, sent through a messaging application, published as an image, linked from a public page, embedded in an event listing, or otherwise shared outside the native application. A recipient may use the ticket-like object or machine-readable element to request access, follow a public profile, join a group, or view location-coded information according to the ticket payload and associated access-control rules.

Although FIG. 9 is described with respect to group, public profile, and social coordination embodiments, similar interface elements may be used for individual profiles, private invitations, event pages, travel groups, organization profiles, family groups, team travel, fan accounts, topic profiles, or other contexts in which coded location objects and ticket-like objects are used to communicate location-related information with controlled visibility and precision.

### Example User Interface Screens

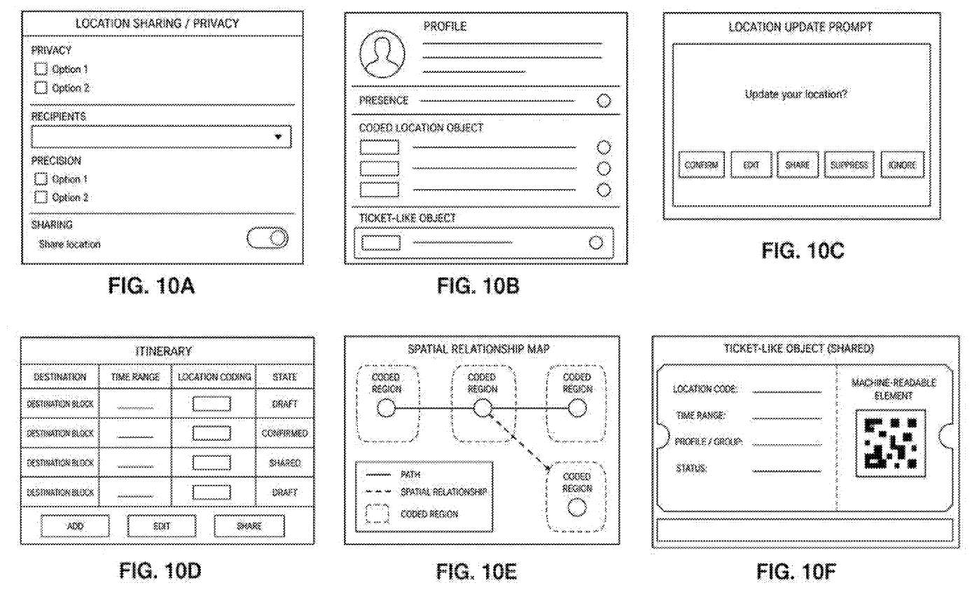

FIGS. 10A-10F illustrate example user interface screens that may be used in connection with one or more embodiments of the privacy-preserving location coding, ticket-like sharing, itinerary composition, and social coordination techniques described herein. The user interface screens shown in FIGS. 10A-10F are merely examples, and other arrangements, layouts, fields, icons, controls, colors, labels, visual states, or interaction patterns may be used.

In one or more embodiments, FIG. 10A may illustrate an example location-sharing or privacy-control interface. The interface may allow a user to select whether location-related information is private, shared with selected contacts, shared with one or more groups, shared with a public or semi-public profile, shared for a limited time, shared at a selected precision level, or not shared. The interface may also allow the user to select whether optional precision descriptors, branch identifiers, ticket-like objects, itinerary segments, or motion-derived prompts are enabled for one or more recipients or groups.

In one or more embodiments, FIG. 10B may illustrate an example location-aware social or profile interface. The interface may display one or more coded location objects, ticket-like objects, destination blocks, user profiles, group profiles, public profiles, or presence indications. For example, the interface may display a current coded location, a future coded destination, a recent update, a group presence indication, or a ticket-like object associated with the user or another profile.

In one or more embodiments, FIG. 10C may illustrate an example travel-detection, travel-confirmation, or location-update prompt interface. The interface may be displayed after the system identifies a candidate travel event, location transition, calendar-derived destination, scanned credential, or other location-related signal. The prompt may request that the user confirm, edit, share, suppress, ignore, revoke, expire, or otherwise manage a coded location object, destination block, itinerary segment, or ticket-like object.

In one or more embodiments, FIG. 10D may illustrate an example calendar-derived or itinerary-derived interface. The interface may display destination blocks, itinerary segments, time ranges, coded location identifiers, draft states, confirmed states, shared states, private states, group indicators, or prompts. In some embodiments, the interface may allow the user to merge, split, confirm, edit, share, suppress, or delete one or more destination blocks generated from calendar entries, travel records, scanned credentials, peer updates, or motion-derived signals.

In one or more embodiments, FIG. 10E may illustrate an example map-related or spatial relationship interface. The interface may display generalized paths, location-coded regions, spatial-grid representations, dotted or solid travel paths, map-like backgrounds, or other spatial relationship indicators associated with one or more coded location objects. Such visual elements may be generated or displayed at a coarse level, branch level, optional precision level, or other level based on user settings, recipient permissions, available spatial index data, or application context.

In one or more embodiments, FIG. 10F may illustrate an example exported, shared, imported, or externally displayed ticket-like object. The ticket-like object may include a short-form location identifier, time range, profile or group identifier, machine-readable element, ticket payload reference, visibility indicator, decorative element, or other information. The ticket-like object may be shared as an image, screenshot, message attachment, social media post, printout, animation, video frame, or other off-network artifact, and may be scanned or imported by another device to initiate validation, onboarding, connection, following, group access, itinerary access, plan cloning, or another controlled interaction.

The particular screens illustrated in FIGS. 10A-10F are not intended to limit the scope of the disclosure. Rather, the screens illustrate example ways in which the location coding, coded location object, ticket-like interface, calendar-derived itinerary, motion-derived prompt, and social coordination techniques described herein may be presented to or controlled by a user.

### Additional, Alternative, or Optional Embodiments

In one or more embodiments, coded location objects, ticket-like objects, destination blocks, itinerary segments, or related interfaces may be associated with additional features that enhance user interaction, personalization, travel coordination, event participation, or controlled sharing. Such features may be implemented individually or in any suitable combination, and are not required in all embodiments.

For example, a ticket-like interface may be customized using one or more visual themes, colors, fonts, textures, simulated materials, stickers, stamps, badges, achievements, animations, particle effects, map-like backgrounds, spatial-grid patterns, decorative borders, or other visual elements. In some embodiments, one or more visual elements may be selected by a user, provided by an application, associated with a particular location coding, unlocked based on travel activity, associated with an event or venue, purchased, subscribed to, sponsored, or otherwise made available. A ticket-like object may therefore function not only as a location interface, but also as a personalized or collectible visual artifact.

In some embodiments, a ticket-like object may be stored, archived, collected, or displayed as part of a travel history, scrapbook, portfolio, memory collection, achievement collection, group album, event archive, or other historical interface. For example, a user may retain past ticket-like objects associated with particular trips, events, destinations, groups, countries, cities, landmarks, bodies of water, or other coded locations. In certain embodiments, a ticket-like object may visually change over time, such as by displaying simulated wear, stamps, aging effects, travel marks, completion indicators, or other modifications based on time, usage, destination completion, viewing, sharing, or other activity.

In one or more embodiments, the system may support travel-related offers, recommendations, advertisements, booking links, affiliate interactions, or “join” or “tag along” workflows. For example, a user viewing another user's ticket-like object or itinerary segment may be presented with an option to search for transportation, lodging, passes, tickets, activities, or events associated with a coded location object or time range. In some embodiments, a user may clone, join, request access to, or express interest in another user's plan, and the system may generate one or more corresponding destination blocks, coded location objects, or ticket-like objects for the requesting user.

In certain embodiments, a physical or digital travel credential may be scanned, imported, photographed, or otherwise processed to generate or update a coded location object. For example, a boarding pass, train ticket, event ticket, hotel reservation, rental record, cruise record, parking pass, theme park pass, or other credential may include text, barcodes, QR codes, machine-readable strips, images, or metadata from which an origin, destination, date, time, carrier, event, venue, or other location-related information may be derived. The mobile device may resolve such information using the spatial index and may generate one or more coded location objects, destination blocks, itinerary segments, prompts, or ticket-like interfaces.

The system may also support ephemeral, sponsored, temporary, or event-specific regions. For example, an event organizer, venue, brand, application operator, or other entity may define a temporary event code, sponsored code, festival code, venue code, convention code, sports event code, resort code, campus code, or other region identifier associated with a particular location and time period. Such a region identifier may be included in a spatial index package, downloaded as optional metadata, associated with a ticket-like object, displayed as an optional precision descriptor, or used to trigger event-specific prompts, themes, offers, group interfaces, or access controls.

In one or more embodiments, coded location objects or ticket-like objects may be used with one or more decentralized, federated, or interoperable communication systems. For example, ticket payloads, location codings, plain-text codes, signed credentials, public profile updates, or group invitations may be transmitted through or referenced by one or more external social networks, messaging systems, decentralized identifiers, blockchain systems, federated protocols, web links, or other external communication mechanisms. In such embodiments, a coded location object may be represented in a compact text form, encoded form, signed form, encrypted form, image form, or other form suitable for communication outside of a native application environment.

In some embodiments, the system may include safeguards, filters, limits, or interaction rules to reduce unwanted disclosure, over-sharing, distraction, or unwanted social interaction. For example, a user may limit read receipts, suppress prompts, restrict visibility by recipient or group, hide optional precision descriptors, disable public ticket access, revoke ticket credentials, expire ticket-like objects, prevent plan cloning, limit contact discovery, or require confirmation before sharing a coded location object. Such controls may be applied globally, per recipient, per group, per ticket, per location coding, per time range, or per application mode.

The embodiments described herein may be implemented using any suitable combination of hardware, software, firmware, data structures, communication protocols, cryptographic techniques, user interface elements, or distributed computing resources. Although certain examples describe operations performed by a mobile device, any of the operations may be performed by one or more mobile devices, servers, peer devices, cloud services, edge devices, wearable devices, desktop devices, or other computing devices, unless expressly stated otherwise.

In one or more embodiments, a spatial index, coded location object, ticket payload, destination block, itinerary segment, user profile, group profile, visibility rule, permission rule, cryptographic key, or other data structure described herein may be stored locally, stored remotely, cached, encrypted, synchronized, transmitted, replicated, versioned, compressed, partially downloaded, or otherwise processed. Such data structures may be represented using any suitable format, including structured records, objects, tables, graphs, trees, arrays, key-value pairs, files, databases, serialized payloads, encrypted payloads, tokens, images, machine-readable codes, plain-text codes, or other representations.

In one or more embodiments, a coded location object may be expressed in a compact text form. For example, a plain-text representation may include one or more symbols, prefixes, separators, country identifiers, regional identifiers, local identifiers, branch identifiers, optional precision descriptors, event identifiers, or other coding elements. Such a text form may be used in messages, social posts, blockchain records, federated protocols, web links, ticket payloads, machine-readable elements, or other constrained communication environments. The format of the text form may vary, and any examples provided herein are illustrative and non-limiting. As an example, a compact text form may be copied, pasted, typed, displayed, spoken, scanned, embedded in a link, included in a message body, or otherwise communicated without requiring an image-based ticket-like object.

In one or more embodiments, machine-readable elements may encode a ticket payload directly or indirectly. For example, a QR code may encode an entire ticket payload, a compressed version of the ticket payload, a signed token, a link, an identifier, a hash, a public key, a credential, a revocation-check reference, or a retrieval reference. In some embodiments, a recipient device may validate a ticket-like object using locally stored information, while in other embodiments the recipient device may contact a server, originating device, distributed ledger, federated service, or other resource to verify status, retrieve metadata, check revocation, or request access.

In one or more embodiments, encryption, signing, authentication, access control, or validation may be implemented using any suitable cryptographic technique. For example, public-key cryptography, symmetric-key cryptography, digital signatures, message authentication codes, nonces, timestamps, certificates, key agreement protocols, encrypted containers, secure enclaves, hardware-backed keys, or other mechanisms may be used. Different fields of a coded location object or ticket payload may be encrypted for different recipients, groups, devices, or access levels.

In one or more embodiments, the spatial index may be based on, derived from, associated with, or interoperable with one or more spatial frameworks, grid systems, map tiling systems, geocoding systems, transportation coding systems, administrative coding systems, time zone databases, event databases, or other data sources. For example, a spatial index may use or map to hierarchical grid cells, polygon datasets, transportation hub identifiers, country or region identifiers, local codes, time zone identifiers, or other geographic references. The particular source, format, resolution, hierarchy, or update mechanism used for the spatial index may vary by implementation.

In one or more embodiments, operations described as being performed locally on a mobile device may nevertheless be supplemented by remote processing, optional metadata retrieval, user confirmation, cached data, preloaded packages, peer-provided data, or other assistance. Conversely, operations described as being performed by a server may be performed locally, by a peer device, or in a distributed manner. The allocation of operations among devices may vary based on privacy goals or requirements, connectivity, storage, processing capacity, battery state, user settings, application design, regulatory requirements, or other factors.

Also, although many examples herein refer to travel, itinerary composition, ticket-like sharing, and social coordination, the location coding techniques may be used in other application contexts in which a precise real-time location is unnecessary or undesirable. For example, weather applications, content-delivery interactions, regionally targeted or limited applications, media applications, compliance applications, advertising applications, messaging applications, or other services may use a coded location object or hierarchical location coding to determine a generalized user context, region, jurisdiction, content region, service region, purchasing region, weather region, language region, network region, or delivery region without requiring repeated transmission of raw geographic coordinates to a remote service. In some embodiments, a mobile device may update or expose such generalized context only when a location signal indicates a meaningful change in a selected coding level, such as a country, region, local area, branch, time zone, or other travel-relevant or application-relevant boundary.

### Specific Example Embodiments

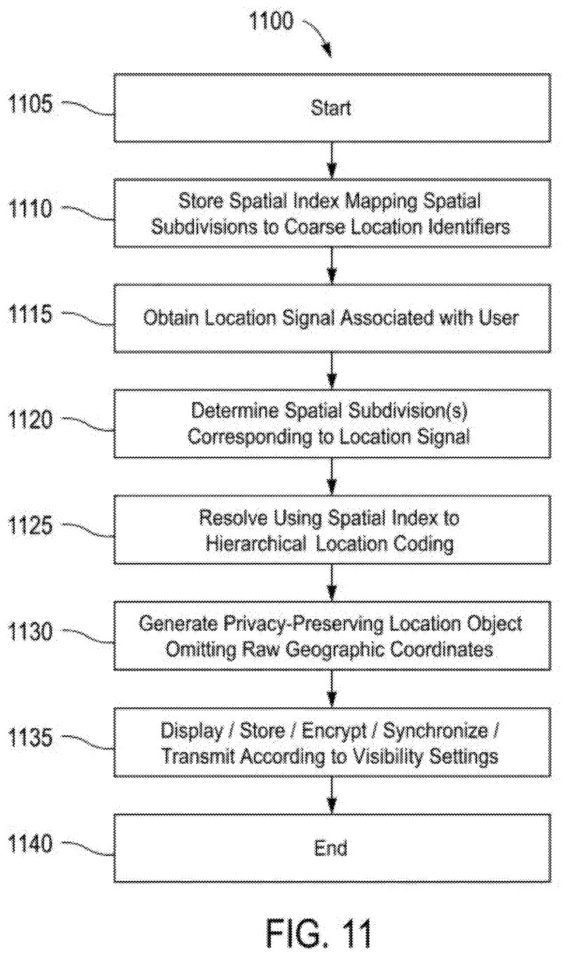

FIG. 11 illustrates an example procedure (method) for on-device spatial index location coding according to one or more embodiments herein. Procedure 1100 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1100 may begin in step 1105, and continues to step 1110, where, as described above, the mobile device stores a spatial index that maps spatial subdivisions to coarse location identifiers. In step 1115, when the mobile device obtains a location signal associated with a user of the mobile device, it may determine in step 1120 one or more spatial subdivisions corresponding to the location signal.

In step 1125, the mobile device may then resolve, using the spatial index, the one or more spatial subdivisions to a hierarchical location coding comprising a human-recognizable location identifier. As such, in step 1130, the mobile device may then generate a privacy-preserving location object based on the hierarchical location coding, wherein the privacy-preserving location object omits raw geographic coordinates of the user, and in step 1135 may cause the privacy-preserving location object to be displayed, stored, encrypted, synchronized, or transmitted according to one or more visibility settings. Procedure 1100 may then end in step 1140.

In one embodiment, the spatial index is stored locally on the mobile device and the resolving is performed without transmitting the raw geographic coordinates of the user to a remote geocoding service.

In one embodiment, the spatial index comprises a reduced-scope spatial index having less geographic detail than a full address-level or point-of-interest-level mapping database.

In one embodiment, the spatial subdivisions comprise cells, polygons, tiles, grid regions, hierarchical spatial identifiers, administrative regions, transportation regions, natural regions, event regions, water regions, or combinations thereof.

In one embodiment, the hierarchical location coding comprises at least two of a continent identifier, country identifier, regional identifier, local identifier, transportation hub identifier, time zone identifier, branch identifier, event identifier, ocean identifier, sea identifier, water-region identifier, or optional precision descriptor.

In one embodiment, the location signal comprises at least one of a device-derived coordinate, operating-system location output, wireless network context, user-entered text, search query, calendar entry, travel reservation, scanned credential, ticket-like object, imported image, message content, peer-shared update, or motion-derived travel signal.

In one embodiment, the procedure may further comprise applying a precision rule to determine whether to include a branch identifier or optional precision descriptor in the privacy-preserving location object. In one embodiment, the precision rule is based on at least one of user input, recipient identity, group membership, relationship type, sharing mode, application setting, event status, time range, or privacy setting.

In one embodiment, the privacy-preserving location object comprises the hierarchical location coding and at least one of temporal information, source information, confidence information, display information, visibility information, expiration information, cryptographic information, sharing permissions, or precision settings.

In one embodiment, the procedure may further comprise encrypting the privacy-preserving location object for one or more selected recipients before transmitting the privacy-preserving location object to a relay server or recipient device.

In one embodiment, the procedure may further comprise generating a ticket-like interface based on the privacy-preserving location object, wherein the ticket-like interface displays the human-recognizable location identifier and includes a machine-readable element associated with a ticket payload.

In one embodiment, the procedure may further comprise generating a destination block or itinerary segment based on the privacy-preserving location object and temporal information associated with the location signal.

In one embodiment, a system herein may comprise: a first mobile device configured to perform procedure 1100; a relay server configured to receive the encrypted privacy-preserving location object from the first mobile device and forward the encrypted privacy-preserving location object without accessing unencrypted location content of the privacy-preserving location object; and a second mobile device configured to receive the encrypted privacy-preserving location object and display location-related information based on the hierarchical location coding according to one or more visibility settings.

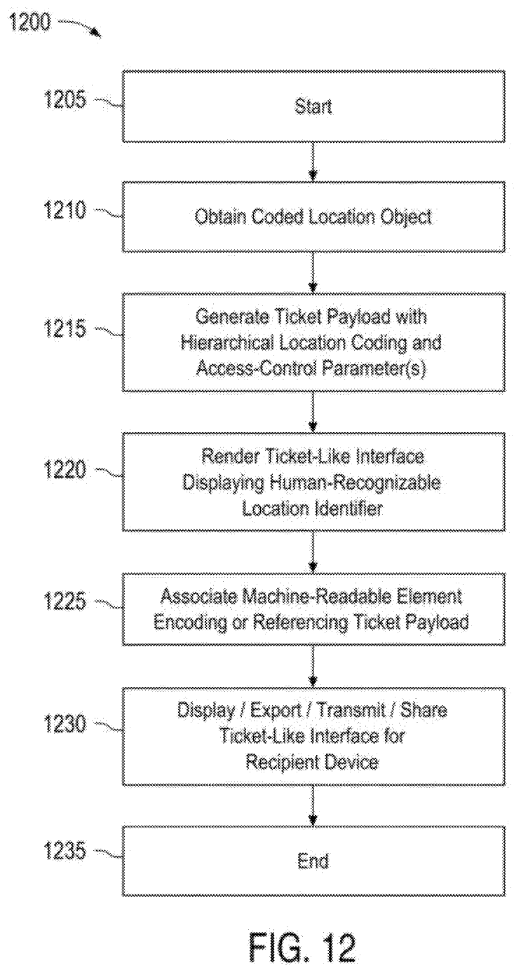

FIG. 12 illustrates an example procedure (method) for providing a ticket-like interface/machine-readable credential according to one or more embodiments herein. Procedure 1200 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1200 may begin in step 1205, and continues to step 1210, where, as described above, the mobile device obtains a coded location object associated with a user, the coded location object comprising a hierarchical location coding corresponding to a general location, destination, travel area, event area, or other geographic area. In step 1215, the mobile device may generate a ticket payload based on the coded location object, the ticket payload comprising the hierarchical location coding and one or more access-control parameters.

In step 1220, the mobile device may render a ticket-like interface based on the ticket payload, the ticket-like interface displaying a human-recognizable location identifier associated with the hierarchical location coding. In step 1225, the mobile device may associate a machine-readable element with the ticket-like interface, the machine-readable element encoding or referencing at least a portion of the ticket payload. In step 1230, the mobile device may cause the ticket-like interface to be displayed, exported, transmitted, or shared for processing by a recipient device. Procedure 1200 may then end in step 1235.

In one embodiment, the coded location object omits raw geographic coordinates of the user.

In one embodiment, the hierarchical location coding comprises at least two of a country identifier, regional identifier, local identifier, transportation hub identifier, time zone identifier, branch identifier, event identifier, body-of-water identifier, or optional precision descriptor.

In one embodiment, the ticket payload comprises at least one of a user identifier, profile identifier, group identifier, public profile identifier, invitation identifier, access scope, visibility setting, precision setting, expiration value, nonce, revocation value, cryptographic signature, or encrypted field.

In one embodiment, the machine-readable element comprises a barcode, QR code, visual pattern, watermark, steganographic marking, encoded text strip, glyph sequence, optical code, link, or NFC-readable element.

In one embodiment, the ticket-like interface is exported as an image, screenshot, animation, video frame, message attachment, social media post, printout, or other off-network artifact.

In one embodiment, the procedure may further comprise receiving, by a recipient device, the ticket-like interface; extracting, by the recipient device, information from the machine-readable element; and validating, by the recipient device or a server, at least one access-control parameter of the ticket payload.

In one embodiment, validating the at least one access-control parameter comprises checking at least one of a cryptographic signature, nonce, expiration value, revocation value, permission scope, user identifier, profile identifier, group identifier, scan count, time restriction, geographic restriction, or access policy.

In one embodiment, the procedure may further comprise initiating, by the recipient device based on the validating, at least one of a connection request, follow request, group-join request, itinerary-access request, plan-cloning workflow, onboarding workflow, profile-viewing workflow, ticket-redemption workflow, or travel-search workflow.

In one embodiment, the ticket-like interface comprises a private invitation ticket configured to permit a recipient to request a connection with the user.

In one embodiment, the ticket-like interface comprises a public-follow ticket configured to permit a recipient to follow a public or semi-public profile without establishing a personal connection with the user.

In one embodiment, the ticket-like interface comprises a group ticket configured to permit a recipient to request access to a group, event, organization, fleet, team, trip, or channel.

In one embodiment, the ticket-like interface comprises at least one of a private invitation ticket, public-follow ticket, group ticket, event ticket, plan ticket, or temporary ticket.

In one embodiment, the ticket-like interface includes one or more selectable fields configured to edit, confirm, suppress, share, revoke, expire, restyle, or otherwise manage the coded location object or ticket payload.

In one embodiment, the coded location object omits raw geographic coordinates of the user and includes a user-selected level of location precision.

In one embodiment, a system herein may comprise: an originating mobile device configured to perform procedure 1200 and generate a ticket-like interface based on a coded location object, the ticket-like interface displaying a human-recognizable location identifier and including a machine-readable element encoding or referencing a ticket payload, the ticket payload comprising a hierarchical location coding and one or more access-control parameters; a recipient mobile device configured to obtain the ticket-like interface, extract information from the machine-readable element, and initiate a validation request based on the ticket payload; and a server configured to validate at least one access-control parameter of the ticket payload and, based on the validation, enable the recipient mobile device to initiate a controlled interaction associated with the originating mobile device, a profile, a group, an itinerary, or a shared location update.

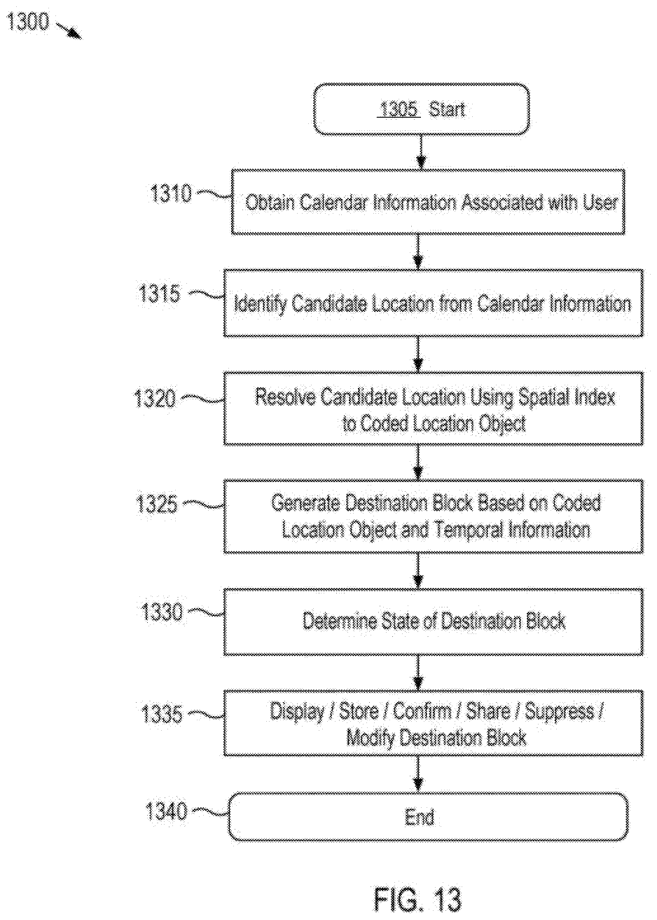

FIG. 13 illustrates an example procedure (method) for calendar-derived itinerary composition according to one or more embodiments herein. Procedure 1300 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1300 may begin in step 1305, and continues to step 1310, where, as described above, the mobile device obtains calendar information associated with a user of the mobile device. In step 1315, the mobile device may identify a candidate location from the calendar information. In step 1320, the mobile device may resolve, using a spatial index, the candidate location to a coded location object comprising a hierarchical location coding.

In step 1325, the mobile device may generate a destination block based on the coded location object and temporal information associated with the calendar information. In step 1330, the mobile device may determine a state of the destination block. In step 1335, the mobile device may cause the destination block to be displayed, stored, confirmed, shared, suppressed, or modified based on the state. Procedure 1300 may then end in step 1340.

In one embodiment, the calendar information comprises at least one of an operating-system calendar entry, application calendar entry, imported calendar feed, travel reservation, event invitation, message, email, ticket, pass, lodging record, transportation record, or user-entered destination.

In one embodiment, identifying the candidate location comprises identifying at least one of a location string, destination name, event name, venue name, transportation identifier, airport code, lodging reference, address, city, region, country, time zone, date range, start time, end time, or attendee reference.

In one embodiment, resolving the candidate location comprises resolving the candidate location locally on the mobile device using the spatial index.

In one embodiment, the coded location object omits raw geographic coordinates of the user.

In one embodiment, the hierarchical location coding comprises at least two of a country identifier, regional identifier, local identifier, transportation hub identifier, time zone identifier, branch identifier, event identifier, body-of-water identifier, or optional precision descriptor.

In one embodiment, the destination block represents that the user is expected to be in, traveling to, arriving at, departing from, attending an event in, or otherwise associated with a coded location during a time range.

In one embodiment, the procedure may further comprise organizing, by the mobile device, a plurality of destination blocks based on temporal information and location coding information.

In one embodiment, organizing the plurality of destination blocks comprises clustering, merging, splitting, sorting, filtering, or arranging destination blocks based on overlapping or adjacent time ranges, shared parent location identifiers, matching local identifiers, branch identifiers, time zone identifiers, event identifiers, group membership, sharing status, confidence information, or source information.

In one embodiment, the state of the destination block comprises at least one of draft, tentative, private, confirmed, shared, public, expired, revoked, stale, inconsistent, or awaiting confirmation.

In one embodiment, the procedure may further comprise comparing, by the mobile device, the destination block to an existing destination block to determine whether to merge the destination block with the existing destination block, generate a new destination block, or present a user prompt.

In one embodiment, the procedure may further comprise presenting, by the mobile device, a prompt suggesting that the user confirm, edit, share, suppress, ignore, revoke, expire, merge, or split the destination block.

In one embodiment, the destination block includes the coded location object, a time range, a sharing status, a confirmation status, and one or more visibility settings.

In one embodiment, a plurality of destination blocks are arranged into an itinerary interface, woven itinerary interface, ticket-like interface, timeline interface, map-related interface, or profile interface.

In one embodiment, the procedure may further comprise generating a ticket-like interface based on the destination block.

In one embodiment, the procedure may further comprise encrypting and transmitting a shared update corresponding to the destination block to one or more selected recipients.

In one embodiment, a system herein may comprise: a mobile device configured to perform procedure 1300, obtain calendar information associated with a user, identify a candidate location from the calendar information, resolve the candidate location using a spatial index to generate a coded location object comprising a hierarchical location coding, generate a destination block based on the coded location object and temporal information associated with the calendar information, and encrypt a shared update corresponding to the destination block; a relay server configured to receive the encrypted shared update from the mobile device and forward the encrypted shared update without accessing unencrypted location content of the coded location object; and a recipient device configured to receive the encrypted shared update and display location-related information associated with the destination block according to one or more visibility settings.

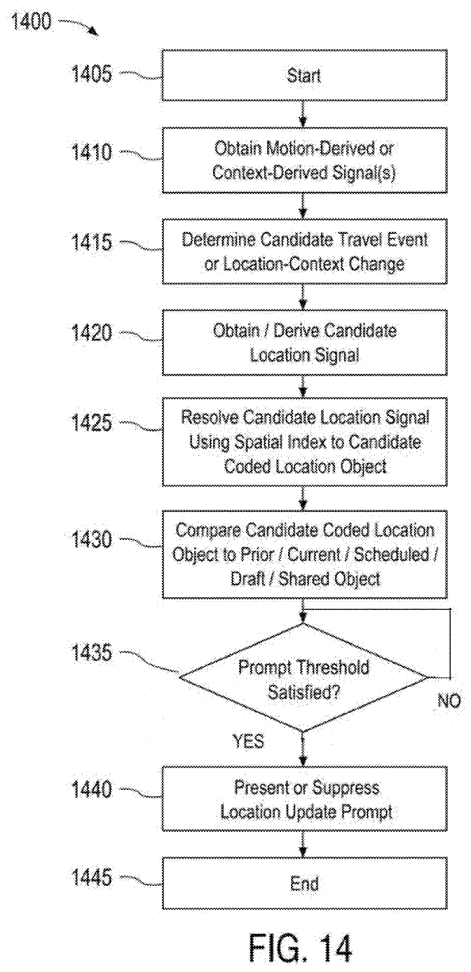

FIG. 14 illustrates an example procedure (method) for motion-derived location update prompts according to one or more embodiments herein. Procedure 1400 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1400 may begin in step 1405, and continues to step 1410, where, as described above, the mobile device obtains one or more motion-derived or context-derived signals associated with a user of the mobile device. In step 1415, the mobile device may determine, based on the one or more motion-derived or context-derived signals, that a candidate travel event or location-context change has occurred. In step 1420, the mobile device may obtain or derive a candidate location signal associated with the candidate travel event or location-context change.

In step 1425, the mobile device may resolve, using a spatial index, the candidate location signal to a candidate coded location object comprising a hierarchical location coding. In step 1430, the mobile device may compare the candidate coded location object to at least one prior, current, scheduled, draft, or shared coded location object. In step 1435, the mobile device may determine, based on the comparing, whether a prompt threshold is satisfied. In step 1440, the mobile device may cause a location update prompt to be presented or suppressed based on whether the prompt threshold is satisfied. Procedure 1400 may then end in step 1445.

In one embodiment, the one or more motion-derived or context-derived signals comprise at least one of accelerometer data, gyroscope data, barometer data, GPS data, operating-system activity classification, airplane-mode status, wireless-network change, cellular-network change, Bluetooth interaction, NFC interaction, vehicle connection status, time zone change, calendar event, travel reservation, scanned credential, or peer update.

In one embodiment, the candidate travel event or location-context change comprises at least one of an arrival event, departure event, transportation event, stationary period, route change, time-zone change, or detected transition between geographic areas.

In one embodiment, the candidate location signal comprises at least one of a device-derived coordinate, operating-system location output, calendar-derived destination, travel-record-derived destination, scanned credential, user-entered location, or peer-shared update.

In one embodiment, the candidate coded location object omits raw geographic coordinates of the user.

In one embodiment, the hierarchical location coding comprises at least two of a country identifier, regional identifier, local identifier, transportation hub identifier, time zone identifier, branch identifier, event identifier, body-of-water identifier, or optional precision descriptor.

In one embodiment, comparing the candidate coded location object to the at least one prior, current, scheduled, draft, or shared coded location object comprises comparing at least one coding level of the candidate coded location object to a corresponding coding level of the at least one prior, current, scheduled, draft, or shared coded location object.

In one embodiment, the at least one coding level comprises at least one of a country level, region level, local level, transportation hub level, branch level, time zone level, event level, body-of-water level, or optional precision level.

In one embodiment, the prompt threshold requires a change in at least one selected coding level before the location update prompt is presented.

In one embodiment, the prompt threshold is based on at least one of user settings, application settings, recipient settings, group settings, device state, confidence level, source type, travel mode, time of day, geographic context, calendar context, or privacy mode.

In one embodiment, when the prompt threshold is satisfied, the location update prompt requests that the user confirm, edit, share, suppress, ignore, revoke, expire, or otherwise manage a location update associated with the candidate coded location object.

In one embodiment, when the prompt threshold is not satisfied, the mobile device suppresses the location update prompt and merges the candidate coded location object into an existing destination block, updates a private current location object, marks an itinerary segment as arrived or departed, updates a ticket-like interface locally, or takes no action.

In one embodiment, the one or more motion-derived or context-derived signals comprise at least one sensor-derived signal and at least one calendar-derived or travel-record-derived signal.

In one embodiment, the mobile device resolves the candidate location signal locally using the spatial index without transmitting raw geographic coordinates of the user to a remote geocoding service.

In one embodiment, when the prompt threshold is satisfied, the procedure may further comprise presenting the location update prompt with at least one suggested recipient, suggested group, suggested precision level, suggested time range, suggested ticket field, suggested itinerary segment, or suggested visibility setting.

In one embodiment, when the prompt threshold is not satisfied, the procedure may further comprise updating a local state without generating a shared location update.

In one embodiment, the procedure may further comprise generating a ticket-like interface, destination block, itinerary segment, profile indication, group update, or encrypted shared payload based on user input received in response to the location update prompt.

In one embodiment, a system herein may comprise: a mobile device configured to perform procedure 1400, obtain one or more motion-derived or context-derived signals associated with a user, determine that a candidate travel event or location-context change has occurred, obtain or derive a candidate location signal associated with the candidate travel event or location-context change, resolve the candidate location signal using a spatial index to generate a candidate coded location object, compare the candidate coded location object to at least one prior, current, scheduled, draft, or shared coded location object, and generate an encrypted location update in response to determining that a prompt threshold is satisfied; a relay server configured to receive the encrypted location update from the mobile device and forward the encrypted location update without accessing unencrypted location content of the candidate coded location object; and a recipient device configured to receive the encrypted location update and display location-related information associated with the candidate coded location object according to one or more visibility settings.

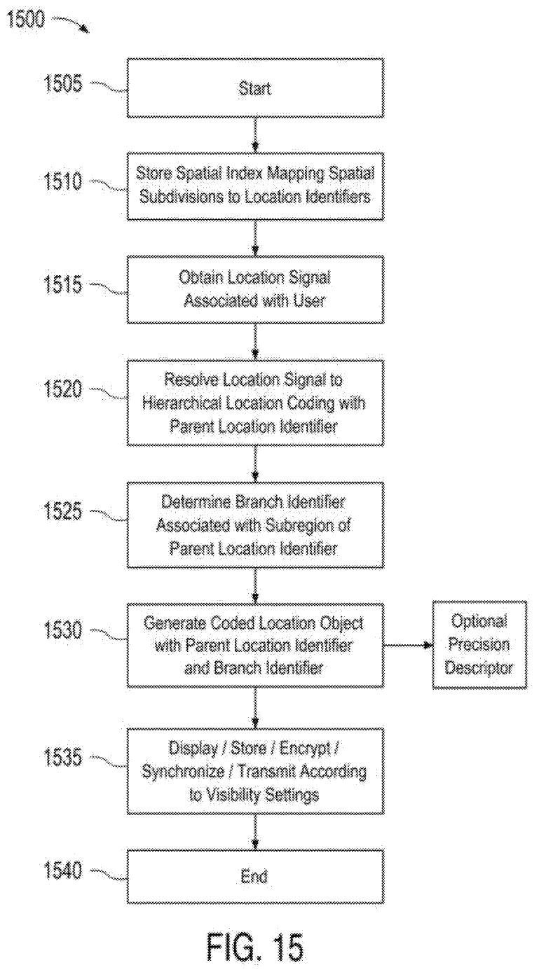

FIG. 15 illustrates an example procedure (method) for branch identifiers/optional precision descriptors according to one or more embodiments herein. Procedure 1500 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1500 may begin in step 1505, and continues to step 1510, where, as described above, the mobile device stores a spatial index that maps spatial subdivisions to location identifiers. In step 1515, the mobile device may obtain a location signal associated with a user of the mobile device. In step 1520, the mobile device may resolve, using the spatial index, the location signal to a hierarchical location coding comprising a parent location identifier.

In step 1525, the mobile device may determine a branch identifier associated with a subregion of the parent location identifier. In step 1530, the mobile device may generate a coded location object comprising the parent location identifier and the branch identifier. In step 1535, the mobile device may cause the coded location object to be displayed, stored, encrypted, synchronized, or transmitted according to one or more visibility settings. Procedure 1500 may then end in step 1540.

In one embodiment, the parent location identifier comprises at least one of a country identifier, regional identifier, local identifier, transportation hub identifier, ocean identifier, sea identifier, water-region identifier, event identifier, or destination-area identifier.

In one embodiment, the branch identifier identifies a portion, sector, subregion, landmark area, venue area, neighborhood, park area, island area, transportation area, event area, or other area within or associated with the parent location identifier.

In one embodiment, the branch identifier is unique within the parent location identifier and is not globally unique across all parent location identifiers.

In one embodiment, the branch identifier is determined based on one or more spatial subdivisions associated with the subregion.

In one embodiment, the one or more spatial subdivisions comprise cells, polygons, grid regions, tile identifiers, hierarchical spatial identifiers, or other spatial subdivisions associated with the subregion.

In one embodiment, the procedure may further comprise generating the branch identifier based on a selected set of spatial subdivisions that distinguish the subregion from other subregions associated with the parent location identifier.

In one embodiment, the branch identifier comprises a stable alphanumeric identifier generated from a sample, hash, name, encoding, ordering, or transformation of one or more spatial subdivision identifiers.

In one embodiment, the spatial index represents the subregion using a centroid, bounding region, set of representative cells, simplified polygon, boundary reference, containment relationship, inherited boundary, or other compact representation.

In one embodiment, the procedure may further comprise applying a precision rule to determine whether to include an optional precision descriptor in the coded location object.

In one embodiment, the optional precision descriptor identifies a venue, point of interest, landmark, neighborhood, park, building, terminal, gate, resort, attraction, event space, custom label, user-entered description, or other more specific location detail.

In one embodiment, the optional precision descriptor is included in the coded location object for a first recipient and omitted from a version of the coded location object generated for a second recipient.

In one embodiment, the branch identifier is interpreted together with the parent location identifier to identify the subregion.

In one embodiment, the spatial index represents the subregion using less boundary detail than a full map representation of the subregion.

In one embodiment, the precision rule is based on at least one of user input, recipient identity, group membership, relationship type, sharing mode, application setting, event status, time range, or privacy setting.

In one embodiment, the coded location object omits raw geographic coordinates of the user and includes a user-selected level of location precision.

In one embodiment, a system herein may comprise: a first mobile device configured to perform procedure 1500, resolve a location signal using a spatial index to generate a coded location object comprising a parent location identifier and a branch identifier associated with a subregion of the parent location identifier, and encrypt the coded location object according to one or more visibility settings; a relay server configured to receive the encrypted coded location object from the first mobile device and forward the encrypted coded location object without accessing unencrypted location content of the coded location object; and a second mobile device configured to receive the encrypted coded location object and display location-related information based on the parent location identifier and the branch identifier according to the one or more visibility settings.

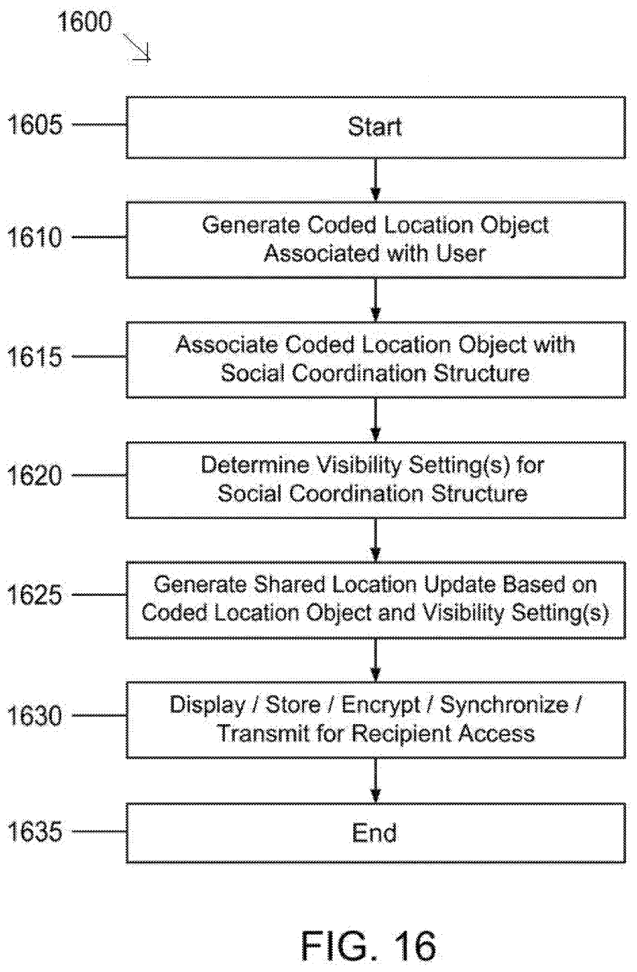

FIG. 16 illustrates an example procedure (method) for group/public profile/social coordination according to one or more embodiments herein. Procedure 1600 may illustratively be performed by a mobile device (e.g., an implementation of device 200 above) having one or more processors; one or more communication interfaces; a user interface; and one or more memories storing instructions that, when executed by the one or more processors, cause the mobile device to perform the process, accordingly.

Procedure 1600 may begin in step 1605, and continues to step 1610, where, as described above, the mobile device generates a coded location object associated with a user, the coded location object comprising a hierarchical location coding corresponding to a general location, destination, travel area, event area, or other geographic area. In step 1615, the mobile device may associate the coded location object with a social coordination structure comprising at least one of a contact, group, organization, public profile, semi-public profile, persona, event, trip, fleet, team, channel, or venue.

In step 1620, the mobile device may determine one or more visibility settings for the social coordination structure. In step 1625, the mobile device may generate a shared location update based on the coded location object and the one or more visibility settings. In step 1630, the mobile device may cause the shared location update to be displayed, stored, encrypted, synchronized, or transmitted for access by one or more recipients associated with the social coordination structure. Procedure 1600 may then end in step 1635.

In one embodiment, the coded location object omits raw geographic coordinates of the user.

In one embodiment, the hierarchical location coding comprises at least two of a country identifier, regional identifier, local identifier, transportation hub identifier, time zone identifier, branch identifier, event identifier, body-of-water identifier, or optional precision descriptor.

In one embodiment, the one or more visibility settings define different levels of location precision for different recipients, groups, public profiles, semi-public profiles, or social coordination structures.

In one embodiment, the procedure may further comprise generating, by the mobile device, a group-level ticket-like object associated with the social coordination structure.

In one embodiment, the group-level ticket-like object comprises at least one of a coded location object, destination block, time range, member indicator, group permission, machine-readable element, invitation payload, public-follow credential, private-access credential, or access-control policy.

In one embodiment, the procedure may further comprise causing the group-level ticket-like object to be shared, exported, transmitted, posted, displayed, scanned, imported, or otherwise processed by a recipient device.

In one embodiment, the procedure may further comprise determining that a plurality of users associated with the social coordination structure have coded location objects corresponding to a same or related location coding during overlapping or nearby time ranges.

In one embodiment, the procedure may further comprise generating an aggregated presence indication based on the determining.

In one embodiment, the aggregated presence indication identifies that one or more contacts, group members, public profiles, semi-public profiles, event participants, or other entities are associated with the same or related location coding during a relevant time period.

In one embodiment, the procedure may further comprise generating a public-follow ticket configured to permit a recipient to follow a public or semi-public profile without establishing a personal connection with the user.

In one embodiment, the procedure may further comprise generating a private-access ticket configured to permit a recipient to request access to a private group, shared itinerary, coded location update, or destination block.

In one embodiment, the one or more visibility settings define a first level of location precision for a first recipient and a second level of location precision for a second recipient.

In one embodiment, the group-level ticket-like object comprises a machine-readable element associated with a group-access credential, public-follow credential, private-access credential, invitation payload, or access-control policy.

In one embodiment, the procedure may further comprise generating an aggregated presence indication based on determining that multiple users associated with the social coordination structure have coded location objects corresponding to a same or related location coding during overlapping or nearby time ranges.

In one embodiment, the procedure may further comprise encrypting the shared location update for one or more selected recipients before transmitting the shared location update to a relay server or recipient device.

In one embodiment, the shared location update is associated with a public profile, semi-public profile, group profile, event profile, organization profile, topic profile, or persona profile.

In one embodiment, a system herein may comprise: an originating mobile device configured to perform procedure 1600, generate a coded location object associated with a user, associate the coded location object with a social coordination structure, determine one or more visibility settings for the social coordination structure, and encrypt a shared location update based on the coded location object and the one or more visibility settings; a relay server configured to receive the encrypted shared location update from the originating mobile device and forward the encrypted shared location update without accessing unencrypted location content of the coded location object; and a recipient device configured to receive the encrypted shared location update and display location-related information associated with the social coordination structure according to the one or more visibility settings.

It should be appreciated that the specific embodiments described herein are not mutually exclusive. Although certain features may be described in connection with particular examples, figures, workflows, claim sets, or implementation categories, any feature, operation, data structure, interface element, privacy control, spatial indexing technique, location coding technique, ticket-related feature, calendar-related feature, motion-derived prompt feature, branch or precision feature, group or public-profile feature, encryption feature, sharing feature, or access-control feature described herein may be combined with any other feature described herein in any suitable manner. Accordingly, embodiments may include combinations of features drawn from different sections of this disclosure, even where such combinations are not separately or expressly described as standalone examples, provided that the combined features are not technically incompatible.

### Conclusion

The foregoing examples are intended to illustrate various embodiments and implementation options. No particular figure, interface, data structure, code format, spatial resolution, geographic hierarchy, ticket design, machine-readable element, communication protocol, or processing location is required unless expressly recited in a claim.

It should be understood that the examples and embodiments described above are illustrative and not limiting. The techniques described herein may be implemented in many different forms and may be used with different devices, networks, data structures, user interfaces, communication protocols, privacy settings, location coding schemes, spatial indexing techniques, ticket-like interfaces, calendar systems, social coordination systems, and sharing workflows.

Although certain embodiments are described with respect to travel-related location information, the techniques herein may also be applied to other contexts in which location-related information is resolved, coded, displayed, shared, synchronized, or controlled at a selected level of precision. For example, the techniques may be used in connection with events, organizations, teams, public profiles, private groups, venue access, field operations, education, entertainment, tourism, logistics, emergency coordination, wellness applications, or other applications involving user-controlled communication of location-related information.

The order of steps in the procedures described herein is not intended to be limiting. Steps may be reordered, combined, divided, omitted, repeated, or performed in parallel. Likewise, features described with respect to one embodiment may be combined with features of another embodiment unless such combination is technically incompatible. A feature described as optional, example, illustrative, or non-limiting need not be included in every implementation.

The terms used herein should be interpreted broadly unless otherwise required by context. For example, references to a “mobile device” may include a smartphone, tablet, wearable device, portable computer, vehicle computing device, augmented-reality device, or other movable or user-associated computing device. References to a “spatial index” may include any data structure that associates spatial subdivisions, regions, cells, polygons, identifiers, or other geographic representations with one or more location identifiers. References to a “ticket-like object” or “ticket-like interface” may include any visual, digital, machine-readable, scannable, importable, shareable, or credential-bearing object or interface that represents or provides access to location-related information.

While certain operations are described as being performed by a mobile device, server, recipient device, originating device, or other component, such operations may be performed by any suitable device or combination of devices. Further, while certain examples describe locally resolving location-related information using a spatial index, other embodiments may use local, remote, cached, distributed, peer-provided, or hybrid processing, depending on implementation.

Accordingly, the scope of the invention is not limited to the particular examples described herein, but is defined by the claims that follow and their equivalents.

What is claimed is:

1. A method, comprising:
storing, by a mobile device, a spatial index that maps spatial subdivisions to coarse location identifiers;
obtaining, by the mobile device, a location signal associated with a user of the mobile device;
determining, by the mobile device, one or more spatial subdivisions corresponding to the location signal;
resolving, by the mobile device using the spatial index, the one or more spatial subdivisions to a hierarchical location coding comprising a human-recognizable location identifier;
generating, by the mobile device, a privacy-preserving location object based on the hierarchical location coding, wherein the privacy-preserving location object omits raw geographic coordinates of the user; and
causing, by the mobile device, the privacy-preserving location object to be displayed, stored, encrypted, synchronized, or transmitted according to one or more visibility settings.

2. The method of claim 1, wherein the spatial index is stored locally on the mobile device and the resolving is performed without transmitting the raw geographic coordinates of the user to a remote geocoding service.

3. The method of claim 1, wherein the spatial index comprises a reduced-scope spatial index having less geographic detail than a full address-level or point-of-interest-level mapping database.

4. The method of claim 1, wherein the spatial subdivisions comprise cells, polygons, tiles, grid regions, hierarchical spatial identifiers, administrative regions, transportation regions, natural regions, event regions, water regions, or combinations thereof.

5. The method of claim 1, wherein the hierarchical location coding comprises at least two of a continent identifier, country identifier, regional identifier, local identifier, transportation hub identifier, time zone identifier, branch identifier, event identifier, ocean identifier, sea identifier, water-region identifier, or optional precision descriptor.

6. The method of claim 1, wherein the location signal comprises at least one of a device-derived coordinate, operating-system location output, wireless network context, user-entered text, search query, calendar entry, travel reservation, scanned credential, ticket-like object, imported image, message content, peer-shared update, or motion-derived travel signal.

7. The method of claim 1, further comprising applying a precision rule to determine whether to include a branch identifier or optional precision descriptor in the privacy-preserving location object.

8. The method of claim 7, wherein the precision rule is based on at least one of user input, recipient identity, group membership, relationship type, sharing mode, application setting, event status, time range, or privacy setting.

9. The method of claim 1, wherein the privacy-preserving location object comprises the hierarchical location coding and at least one of temporal information, source information, confidence information, display information, visibility information, expiration information, cryptographic information, sharing permissions, or precision settings.

10. The method of claim 1, further comprising encrypting, by the mobile device, the privacy-preserving location object for one or more selected recipients before transmitting the privacy-preserving location object to a relay server or recipient device.

11. The method of claim 1, further comprising:
generating, by the mobile device, a ticket-like interface based on the privacy-preserving location object, wherein the ticket-like interface displays the human-recognizable location identifier and includes a machine-readable element associated with a ticket payload.

12. The method of claim 1, further comprising:
generating, by the mobile device, a destination block or itinerary segment based on the privacy-preserving location object and temporal information associated with the location signal.

13. A mobile device comprising:
one or more processors;
one or more communication interfaces;
a user interface; and
one or more memories storing instructions that, when executed by the one or more processors, cause the mobile device to:
store a spatial index that maps spatial subdivisions to coarse location identifiers;
obtain a location signal associated with a user of the mobile device;
determine one or more spatial subdivisions corresponding to the location signal;
resolve, using the spatial index, the one or more spatial subdivisions to a hierarchical location coding comprising a human-recognizable location identifier;
generate a privacy-preserving location object based on the hierarchical location coding, wherein the privacy-preserving location object omits raw geographic coordinates of the user; and
cause the privacy-preserving location object to be displayed, stored, encrypted, synchronized, or transmitted according to one or more visibility settings.

14. The mobile device of claim 13, wherein the spatial index is stored locally on the mobile device and is configured to permit the mobile device to resolve the location signal without transmitting the raw geographic coordinates of the user to a remote geocoding service.

15. The mobile device of claim 13, wherein the spatial index comprises a reduced-scope spatial index that maps spatial subdivisions to travel-relevant location identifiers corresponding to cities, regions, countries, transportation hubs, destination areas, event areas, bodies of water, islands, parks, landmarks, or other coarse geographic areas.

16. The mobile device of claim 13, wherein the hierarchical location coding comprises at least two of a country identifier, regional identifier, local identifier, transportation hub identifier, time zone identifier, branch identifier, event identifier, body-of-water identifier, or optional precision descriptor.

17. The mobile device of claim 13, wherein the instructions, when executed by the one or more processors, further cause the mobile device to apply a precision rule to determine whether to include a branch identifier or optional precision descriptor in the privacy-preserving location object.

18. The mobile device of claim 13, wherein the instructions, when executed by the one or more processors, further cause the mobile device to encrypt the privacy-preserving location object for one or more selected recipients before transmitting the privacy-preserving location object to a relay server or recipient device.

19. The mobile device of claim 13, wherein the instructions, when executed by the one or more processors, further cause the mobile device to generate a ticket-like interface or itinerary segment based on the privacy-preserving location object.

20. A system comprising:
a first mobile device comprising one or more processors and one or more memories storing instructions that, when executed by the one or more processors, cause the first mobile device to:
store a spatial index that maps spatial subdivisions to coarse location identifiers;
obtain a location signal associated with a user of the first mobile device;
determine one or more spatial subdivisions corresponding to the location signal;
resolve, using the spatial index, the one or more spatial subdivisions to a hierarchical location coding comprising a human-recognizable location identifier;
generate a privacy-preserving location object based on the hierarchical location coding, wherein the privacy-preserving location object omits raw geographic coordinates of the user; and
encrypt the privacy-preserving location object for one or more selected recipients;
a relay server configured to receive the encrypted privacy-preserving location object from the first mobile device and forward the encrypted privacy-preserving location object without accessing unencrypted location content of the privacy-preserving location object; and
a second mobile device configured to receive the encrypted privacy-preserving location object and display location-related information based on the hierarchical location coding according to one or more visibility settings.
